(19) United States
(12) Patent Application Publication
(10) Pub. No.: US 2026/0125221 A1
(43) Pub. Date: May 7, 2026

(54) DEVICE, SYSTEM, AND METHOD FOR AUTOMATED MATERIAL DELIVERY TO A DISPENSING MACHINE

(71) Applicant: Nordson Corporation, Westlake, OH (US)

(72) Inventors: Cutler CROWELL, Westlake, OH (US); Alan LEWIS, Westlake, OH (US); David PADGETT, Westlake, OH (US); Garrett WONG, Westlake, OH (US)

(73) Assignee: Nordson Corporation, Westlake, OH (US)

(21) Appl. No.: 19/118,065

(22) PCT Filed: Oct. 16, 2023
(86) PCT No.: PCT/US2023/076946

§ 371 Date: Apr. 3, 2025

Related U.S. Application Data
(60) Provisional application No. 63/416,654, filed on Oct. 17, 2022.

(51) Int. Cl. B65G 35/06; B65G 43/02

(52) U.S. Cl. CPC B65G 35/06; B65G 43/02; B65G 2201/0235; B65G 2203/0266

(57) ABSTRACT

In some aspects, a device includes side walls, a top wall, a floor, an interior space, and a back wall; a machine readable code device; at least one power connector configured to provide power to components of the material delivery device; at least one sensor configured to sense a physical characteristic associated with the material delivery device and/or the service element to generate, in part, device related information; a transceiver configured to transmit the device related information to a controller; and a holding mechanism arranged within the interior space and configured to receive and/or securely hold the service element.

### CROSS-REFERENCE TO RELATED APPLICATIONS

This application is a National Stage Application of International Patent App. No. PCT/US 2023/076946, filed Oct. 16, 2023, which claims the benefit of U.S. Provisional Patent App. No. 63/416,654, filed Oct. 17, 2022, the entire disclosures of both of which are hereby incorporated by reference as if set forth in their entirety herein.

### FIELD OF THE DISCLOSURE

The disclosure relates to a device for automated material delivery to a dispensing machine. Additionally, the disclosure relates to a system for automated material delivery to a dispensing machine. Further, the disclosure relates to a method for automated material delivery to a dispensing machine.

### BACKGROUND OF THE DISCLOSURE

In particular device manufacturing, such as semiconductor manufacturing, electronic device manufacturing, and/or the like fabrication typically takes place inside a clean room. In this regard, utilizing a clean room may be central part of a fabrication process. More specifically, the manufacturing may be carried out in a hermetically sealed environment to improve yield, with automated material handling systems taking care of the transport of wafers from machine to machine.

In this regard, Front Opening Unified Pods (FOUPs) are typically used to transport the silicon wafers between various process tools within a factory using an Automated Material Handling-System (AMHS). However, additional supplies are needed for certain manufacturing machines, such as dispensing machines. In this regard, personnel must enter the clean room to provide the additional supplies for these certain manufacturing machines. This results in potential contamination of the clean room and possible impact on the quality of the resulting devices.

Accordingly, what is needed is a device, system, and method for automated material delivery to a machine that will reduce contamination of the clean room and limit impact on the quality of the resulting electronic devices. Moreover, what is needed is a device, system, and method for automated material delivery to a machine that provides data, information, and/or the like for operation, analysis, and/or the like of the various systems associated with the machine.

### SUMMARY OF THE DISCLOSURE

The foregoing needs are met, to a great extent, by the disclosure, wherein in one aspect a device, system, and method for automated material delivery to a machine that will reduce contamination of the clean room and limit impact on the quality of the resulting electronic devices.

In one general aspect, a material delivery device includes side walls, a top wall, a floor, an interior space, and a back wall. The material delivery device in addition includes a machine readable code device. The material delivery device moreover includes at least one power connector configured to provide power to components of the material delivery device. The material delivery device also includes at least one sensor configured to sense a physical characteristic associated with the material delivery device and/or the service element to generate, in part, device related information. The material delivery device further includes a transceiver configured to transmit the device related information to a controller. The material delivery device in addition includes a holding mechanism arranged within the interior space and configured to receive and/or securely hold the service element.

In one general aspect, a material delivery process includes implementing a material delivery device. The material delivery process in addition includes configuring the material delivery device with side walls, a top wall, a floor, an interior space, and a back wall. The material delivery process moreover includes configuring the material delivery device with a machine readable code device. The material delivery process also includes configuring the material delivery device with at least one power connector configured to provide power to components of the material delivery device. The material delivery process further includes configuring the material delivery device with at least one sensor to sense a physical characteristic associated with the material delivery device and/or the service element to generate, in part, device related information. The material delivery process in addition includes configuring the material delivery device with a transceiver to transmit the device related information to a controller. The material delivery process moreover includes configuring the material delivery device with a holding mechanism arranged within the interior space to receive and/or securely hold the service element.

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will form the subject matter of the claims appended hereto.

In this respect, before explaining at least one aspect of the disclosure in detail, it is to be understood that the disclosure is not limited in its application to the details of construction and to the arrangements of the components set forth in the following description or illustrated in the drawings. The disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the disclosure. It is important, therefore, that the claims be regarded as including such equivalent constructions insofar as they do not depart from the spirit and scope of the disclosure.

### BRIEF DESCRIPTION OF THE DRAWINGS

FIG. 1 illustrates an exemplary implementation of a system for automated material delivery according to aspects of the disclosure.

FIG. 2 illustrates a partial view of the system according to FIG. 1.

FIG. 3 illustrates another partial view of the system according to FIG. 1.

FIG. 4 illustrates a front perspective view of a material delivery device according to aspects of the disclosure.

FIG. 5 illustrates a side view of the material delivery device according to FIG. 4.

FIG. 6 illustrates a side view of the material delivery device and the service element according to aspects of the disclosure.

FIG. 7 illustrates a cross-sectional top view of the material delivery device according to aspects of the disclosure.

FIG. 8 illustrates a cross-sectional side view of the material delivery device according to aspects of the disclosure.

FIG. 9 illustrates an exemplary implementation of the transportation system according to aspects of the disclosure.

FIG. 10 illustrates another exemplary implementation of the transportation system according to aspects of the disclosure.

FIG. 11 illustrates an exemplary implementation of the module device and the dispensing machine according to aspects of the disclosure.

FIG. 12 illustrates an exemplary implementation of a robot implemented by a number of different components of the disclosure.

FIG. 13 illustrates a side view of an exemplary implementation of the service element according to aspects of the disclosure.

FIG. 14 illustrates a top view of an exemplary implementation of the service element according to FIG. 13.

FIG. 15 illustrates a partial side view of the dispensing machine according to aspects of the disclosure.

FIG. 16A illustrates a cross-sectional top view of the material delivery device and the service element according to aspects of the disclosure.

FIG. 16B illustrates a cross-sectional side view of the material delivery device and the service element according to FIG. 16A.

FIG. 16C illustrates a cross-sectional top view of the material delivery device and the service element according to aspects of the disclosure.

FIG. 16D illustrates a cross-sectional side view of the material delivery device and the service element according to aspects of the disclosure.

FIG. 17 illustrates exemplary exchange operations according to aspects of the disclosure.

FIG. 18 illustrates further exemplary exchange operations according to aspects of the disclosure.

FIG. 19 illustrates further exemplary exchange operations according to aspects of the disclosure.

FIG. 20 illustrates further exemplary exchange operations according to aspects of the disclosure.

FIG. 21 illustrates another implementation of the module device and/or the dispensing machine according to aspects of the disclosure.

FIG. 22 illustrates a data collection system according to the principles of the disclosure.

FIG. 23 illustrates a process of implementing the system for automated material delivery and/or the data collection system according to principles of the disclosure.

### DETAILED DESCRIPTION

The disclosure will now be described with reference to the drawing figures, in which like reference numerals refer to like parts throughout. Aspects of the disclosure advantageously provide a device, system, and method for automated material delivery to a dispensing machine that will reduce contamination of the clean room and limit impact on the quality of the resulting electronic devices.

In semiconductor manufacturing, Front Opening Unified Pods (FOUPs) are used to transport silicon wafers between various process tools within a factory using an Automated Material Handling-System (AMHS). The disclosure sets forth a device, system, and method implementing a FOUP that has been configured to carry manufacturing supplies to and from different locations within a factory using existing AMHS infrastructure. In aspects, the manufacturing supplies may include one or more material dispensing supplies. In aspects, the manufacturing supplies may include one or more service components, maintenance components, consumable components, service items, maintenance items, consumable items, service elements, maintenance elements, consumable elements, and/or the like, hereinafter service elements for brevity of disclosure. In aspects, the material dispensing supplies or service elements may include one or more valves, syringes of fluid, cleaning strips, fiducial tiles, purge cups, scale cups, cleaning strips, and/or other service elements. The physical interaction between FOUPs and AMHSs is governed by several existing SEMI standards. Accordingly, the device, system, and method implementing a FOUP may be configured with implementations to the FOUP largely limited to internal features of the FOUP.

In aspects, the disclosure sets forth a device, system, and method implementing a FOUP that may be configured to carry several different types of service elements including different combinations of valves, syringes of fluid, cups, cleaning strips, fiducial tiles, purge cups, scale cups, cleaning strips, and/or other service elements depending on the needs of the customer and/or needs of a particular machine.

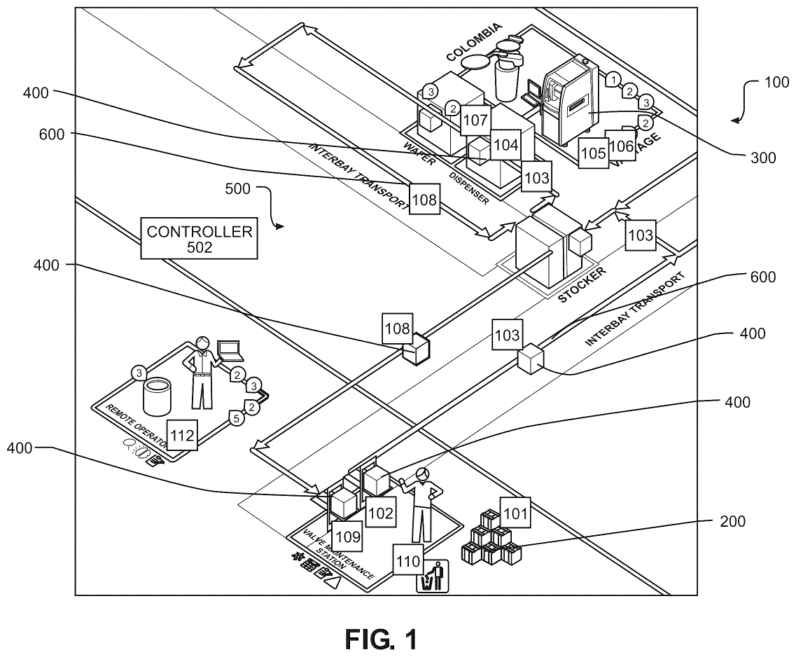

FIG. 1 illustrates an exemplary implementation of a system for automated material delivery according to aspects of the disclosure.

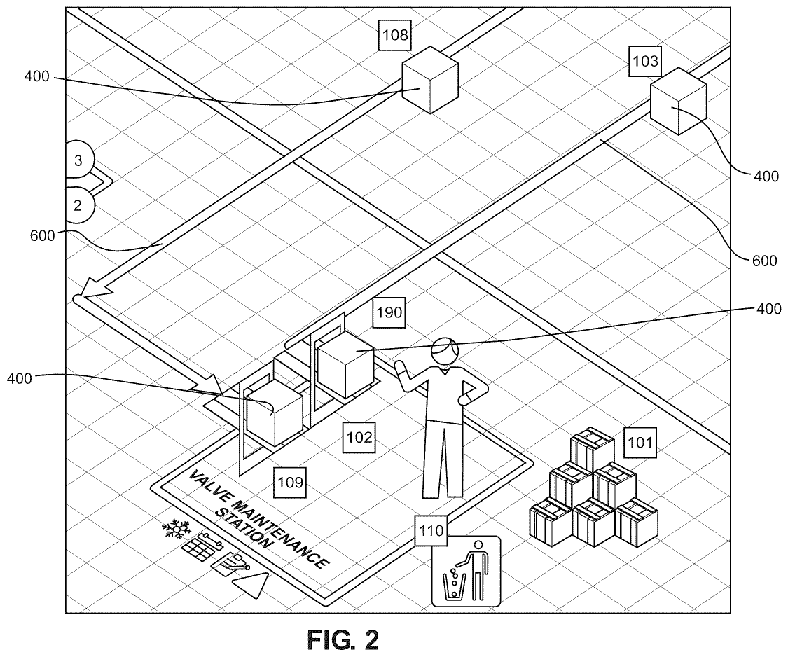

FIG. 2 illustrates a partial view of the system according to FIG. 1.

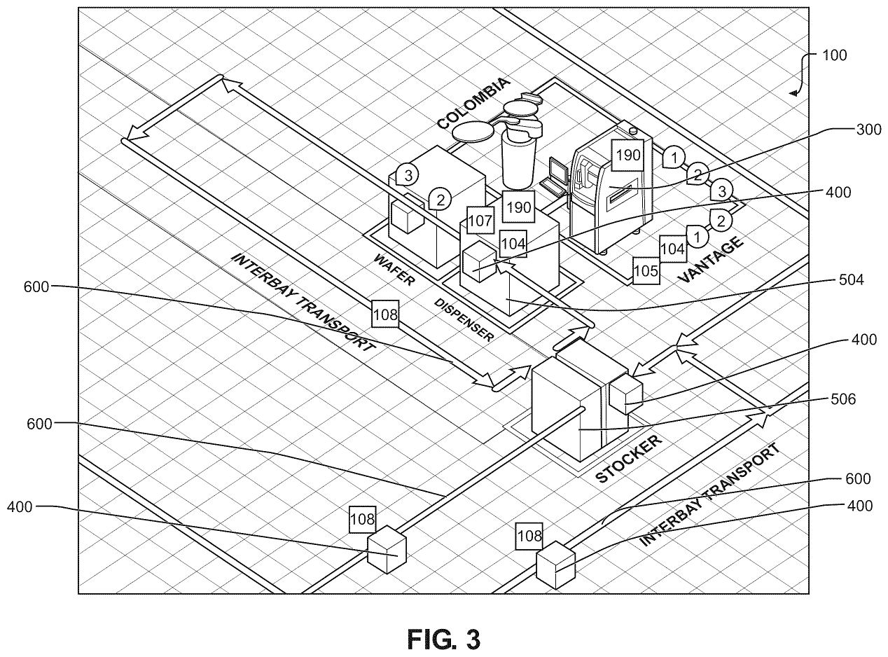

FIG. 3 illustrates another partial view of the system according to FIG. 1.

In particular, FIG. 1 illustrates an exemplary implementation of a system for automated material delivery 100 configured to provide delivery of a service element 200 to a dispensing machine 300 utilizing a material delivery device 400 within a device manufacturing facility 500. In this regard, the service element 200 as contemplated by the disclosure is distinguished from components being manufactured in the device manufacturing facility 500. For example, silicon wafers are not consumed during manufacturing, they are modified. Further, the service element 200 may include a single service element, the service element 200 may include multiple service elements, the service element 200 may include multiple service elements of the same type, and/or the service element 200 may include multiple service elements of different types. Moreover, in aspects, the service element 200 may include multiple service elements of different types combined in a unit to form a servicing package or servicing station. As illustrated in FIG. 1, the service element 200 may be initially located at a supply station 101 and the material delivery device 400 may be initially located at a load station 102. The material delivery device 400 may be configured as further described below to receive the service element 200 at the load station 102. Thereafter, the material delivery device 400 together with the service element 200 may be transported within the device manufacturing facility 500 utilizing a transportation system 600 along a transport path 103 within the device manufacturing facility 500.

Subsequently, the transportation system 600 (illustrated without detailed FIG. 1) may be configured to move the material delivery device 400 together with the service element 200 to a delivery station 104. Thereafter, the service element 200 with or without the material delivery device 400 may be moved along a transport path 105 and/or a transport path 106 to the dispensing machine 300 and locate the service element 200 at the dispensing machine 300. Thereafter, the system for automated material delivery 100 may be configured to provide and/or deliver the service element 200 to the dispensing machine 300. As further described below, aspects may include additional intermediary devices.

Additionally, the material delivery device 400 or a separate implementation of the material delivery device 400 may be configured receive a consumed portion of the service element 200 from the dispensing machine 300. In particular, the system for automated material delivery 100 may be configured to transport the consumed portion of the service element 200 along the transport path 105 and/or the transport path 106 to a station 107. Thereafter, the consumed portion of the service element 200 may be loaded into the material delivery device 400 at the station 107. Once the consumed portion of the service element 200 is loaded into the material delivery device 400, the material delivery device 400 together with the consumed portion of the service element 200 may be carried by the transportation system 600 along a transport path 108 to deliver the consumed portion of the service element 200 from the dispensing machine 300 to an unload station 109. Thereafter, the consumed portion of the service element 200 may be removed from the material delivery device 400 and placed in a disposal station 110.

In aspects, operation, control, oversight, and/or the like of the system for automated material delivery 100, the service element 200, the material delivery device 400, the transportation system 600, and/or the like may be provided by a controller 502. The controller 502 may be responsive to an operator, a remote operator 112, another system, and/or the like.

As illustrated in FIG. 2, personnel may load the material delivery device 400 with the service element 200. In particular, the personnel may be located outside of the device manufacturing facility 500 at the load station 102. Accordingly, personnel located outside the device manufacturing facility 500 may interact with the material delivery device 400 and/or the service element 200 and may be less likely to contaminate the device manufacturing facility 500. More specifically, at the load station 102, the personnel may load the service element 200 from the supply station 101 into the material delivery device 400 at the load station 102. Thereafter, as noted above, the material delivery device 400 may be transported into the device manufacturing facility 500 utilizing the transportation system 600 along the transport path 103 within the device manufacturing facility 500.

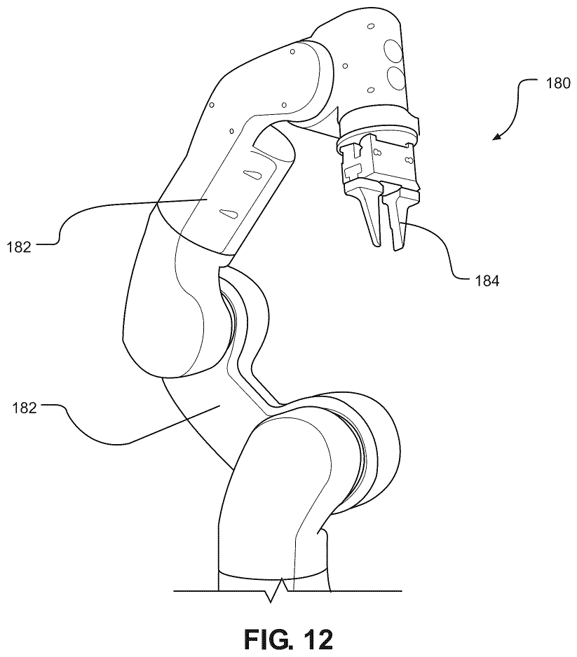

Alternatively or additionally, an automated system may also load the material delivery device 400 with the service element 200 at the load station 102. More specifically, at the load station 102, the automated system may load the service element 200 from the supply station 101 into the material delivery device 400 at the load station 102. Thereafter, as noted above, the material delivery device 400 may be transported into the device manufacturing facility 500 utilizing the transportation system 600 along the transport path 103 within the device manufacturing facility 500. In aspects, the automated system may include a robot 180 as illustrated in FIG. 12.

As further described below, the material delivery device 400, the service element 200, and/or the like may be configured with a machine readable code device. Further, the system for automated material delivery 100 may include a plurality of implementations of a machine code reading device 190 configured to read the machine readable code device of the material delivery device 400, the service element 200, and/or the like. As illustrated in FIG. 2, the system for automated material delivery 100 may include an implementation of the machine code reading device 190 located at the load station 102. At the time the service element 200 is loaded into the material delivery device 400, the machine code reading device 190 may read a machine readable code associated with the service element 200 and/or the material delivery device 400.

As illustrated in FIG. 3, the material delivery device 400 may be transported by the transportation system 600 along the transport path 103 within the device manufacturing facility 500 to the dispensing machine 300. In aspects, the material delivery device 400 may be delivered by the transportation system 600 to a stocker device 506 and/or a module device 504 by the transportation system 600 prior to the material delivery device 400 and/or the service element 200 being delivered to the dispensing machine 300. However, in other aspects, the material delivery device 400 and/or the service element 200 may be delivered to the dispensing machine 300 by the transportation system 600 without delivery to the stocker device 506.

The module device 504 may be configured to receive the material delivery device 400 at the delivery station 104. Thereafter, the module device 504 may remove the service element 200 from the material delivery device 400. In aspects, the service element 200 may be delivered from the module device 504 to the dispensing machine 300 along the transport path 105 and/or the transport path 106. In aspects, the service element 200 may traverse the transport path 105 and/or the transport path 106 and subsequently be installed in the dispensing machine 300.

As illustrated in FIG. 3, the system for automated material delivery 100 may include an implementation of the machine code reading device 190 located at the delivery station 104 and/or the station 107. At the time the service element 200 and/or the material delivery device 400 are located at the station 107 and/or the delivery station 104, the machine code reading device 190 may read a machine readable code associated with the service element 200 and/or the material delivery device 400.

As further illustrated in FIG. 3, the system for automated material delivery 100 may include an implementation of the machine code reading device 190 located at the transport path 105, the transport path 106, and/or the dispensing machine 300. At the time the service element 200 and/or the material delivery device 400 are located at the transport path 105, the transport path 106, and/or the dispensing machine 300, the machine code reading device 190 may read a machine readable code associated with the service element 200 and/or the material delivery device 400.

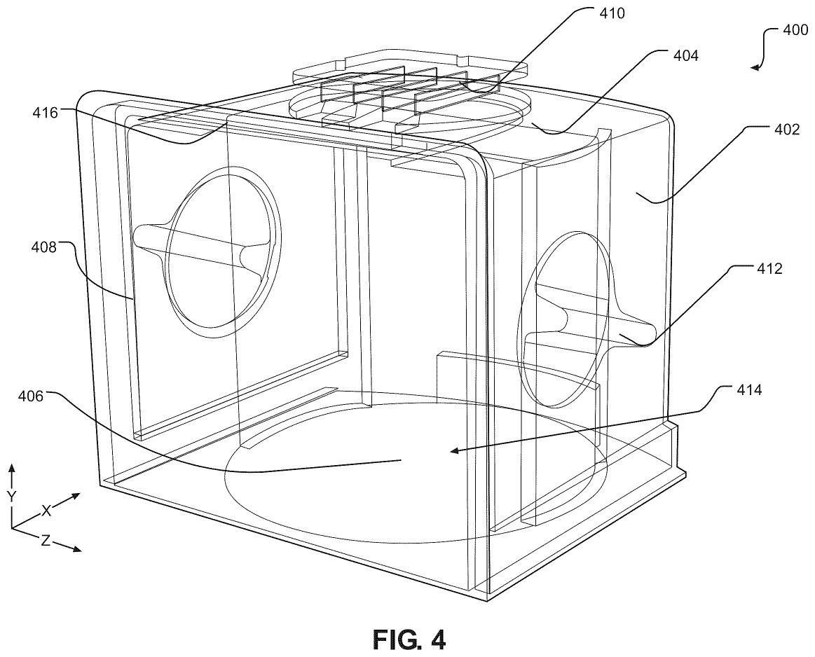

FIG. 4 illustrates a front perspective view of a material delivery device according to aspects of the disclosure.

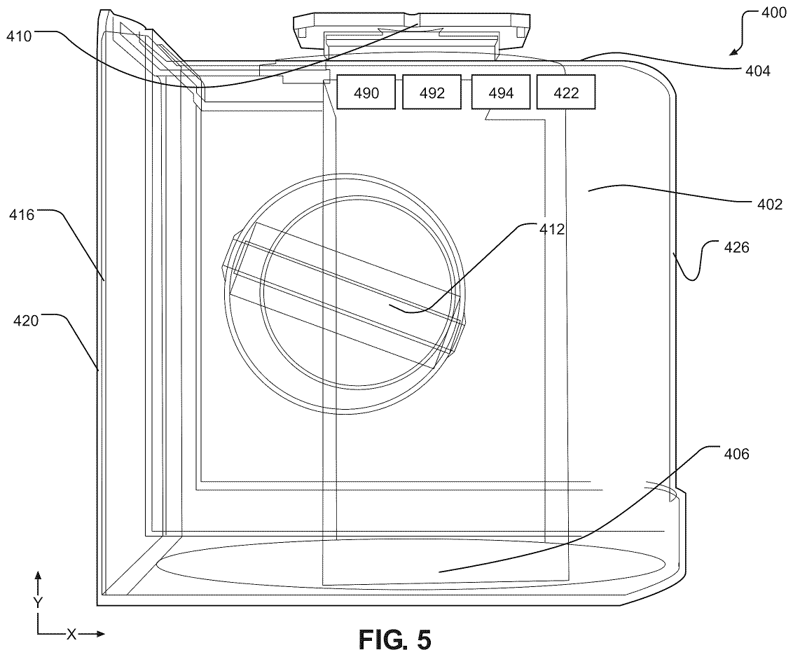

FIG. 5 illustrates a side view of the material delivery device according to FIG. 4.

In particular, FIG. 4 illustrates an exemplary implementation of the material delivery device 400 that may be utilized in conjunction with the system for automated material delivery 100, the service element 200, the dispensing machine 300, the device manufacturing facility 500, the transportation system 600, and/or the like as described herein. In aspects, the material delivery device 400 may have a configuration of a Front Opening Unified Pod (FOUP). A FOUP is a specialized enclosure, which may be plastic, designed to hold silicon wafers securely and safely in a controlled environment, and to allow the wafers to be transferred between machines for processing or measurement. In this regard, the material delivery device 400 of the disclosure may be configured for implementation with the service element 200. In aspects, the material delivery device 400 of the disclosure may be configured to receive, securely hold, and/or the like the service element 200 at the load station 102, the station 107, and/or the like. In particular aspects, the material delivery device 400 may be configured to securely hold, the service element 200 while being moved by the transportation system 600 along the transport path 103, the transport path 108, and/or the like. In particular aspects, the material delivery device 400 may be configured to provide the service element 200 at the delivery station 104, the transport path 105, the transport path 106, the dispensing machine 300, the unload station 109, and/or the like.

In this regard, the material delivery device 400 may include side walls 402, a top wall 404, a floor 406, and an interior space 408. The material delivery device 400 may include two implementations of the side walls 402 on either side of the top wall 404 and the interior space 408. The side walls 402 may be arranged in a plane parallel to the y-axis in the x-axis. Both of the side walls 402 may extend along the y-axis from the floor 406 to the top wall 404. Additionally, the top wall 404 and the floor 406 may extend in a plane parallel to the z-axis and the x-axis between two adjacent implementations of the side walls 402.

Arranged on the top wall 404 of the material delivery device 400 may be a connection assembly 410. The connection assembly 410 may be configured to connect to a component of the transportation system 600 and allow the material delivery device 400 to be carried by the transportation system 600 throughout the device manufacturing facility 500. Additionally, the material delivery device 400 may include handles 412. The handles 412 may be arranged on each of the side walls 402 and may be utilized by personnel to move the material delivery device 400, for example when the material delivery device 400 is outside the device manufacturing facility 500 at the load station 102.

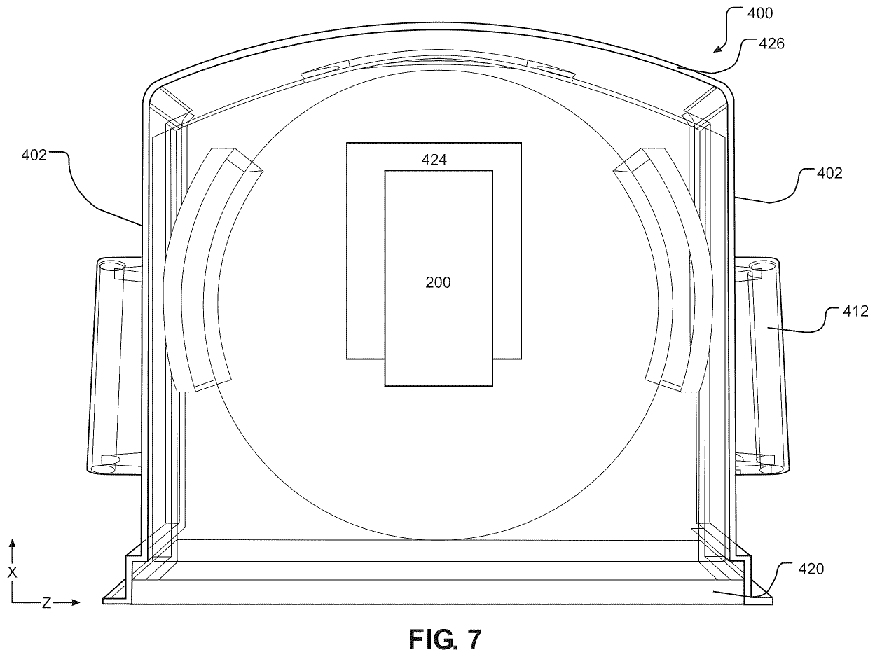

Further, the material delivery device 400 may include an opening 414. The opening 414 may be arranged in the plane parallel to the y-axis and the z-axis. The opening 414 may be defined by a frame 416 attached to and connected to the top wall 404, each of the side walls 402, and/or the like. The opening 414 may provide access to the interior space 408. Additionally, the opening 414 may be covered by a door 420 as illustrated in FIG. 7. In this regard, the material delivery device 400 may further include structure to support the door 420, allow the door 420 to open, and/or the like. In aspects, the material delivery device 400 may be configured to allow the door 420 to slide open along the y-axis, the x-axis, and/or the z-axis. In this aspect, the material delivery device 400 may include structure configured to allow the door 420 to slide. Alternatively or additionally, the material delivery device 400 may be configured to allow the door 420 to rotate open about the y-axis, the x-axis, and/or the z-axis. In this regard, the material delivery device 400 may include structure configured to allow the door 420 to rotate, such as hinges or the like. Further, the opening 414 may be configured to receive the service element 200.

As illustrated in FIG. 5, the material delivery device 400 may include a back wall 426. The back wall 426 may extend from the floor 406 to the top wall 404; and the back wall 426 may extend from the side walls 402 on one side of the material delivery device 400 to the side walls 402 on the other side of the material delivery device 400. The back wall 426 may be arranged opposite the frame 416. Accordingly, the material delivery device 400 may provide an enclosed space between the top wall 404, the side walls 402, the back wall 426, the floor 406, the door 420, and/or the like.

Additionally, the material delivery device 400 may further include a machine-readable code 422. The machine-readable code 422 may be implemented as one or more of a radiofrequency identification (RFID) device, a barcode, a QR code, a Data Matrix (DM) code, and/or the like. In one aspect, the machine-readable code 422 may be a machine-readable code that may be configured to be readable by the machine code reading device 190. In one aspect, the machine-readable code 422 may be an alphanumeric code that may be manually input to a tracking device.

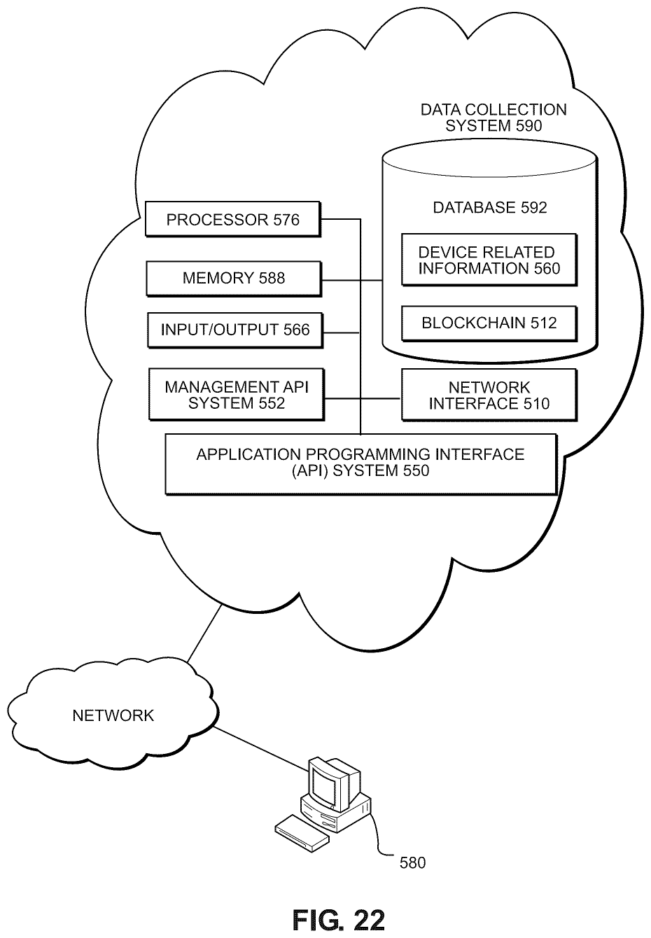

With further reference to FIG. 5, the material delivery device 400 may include at least one sensor 490 to sense a physical characteristic within and/or associated with the material delivery device 400 and/or the service element 200. The at least one sensor 490 may include one or more of an accelerometer, temperature sensor, IR sensor (infrared sensor), pressure sensor, light sensor, ultrasonic sensor, humidity sensor, tilt sensor, level sensor, motion sensor, and/or the like. The material delivery device 400 may further include analog-to-digital converters, filters, and the like to process the signals associated with any of the sensors. In one aspect, the temperature sensor may be a thermocouple, a thermistor, and/or the like. In response to the machine code reading device 190, the machine-readable code 422 may provide one or more of the above noted physical quantities sensed by the sensors as part of device related information 560 to the controller 502, the data collection system 590 illustrated in FIG. 22, another computer system, and/or the like.

Additionally, the material delivery device 400 may include at least one power connector 492 configured to provide power to various aspects of the material delivery device 400. The at least one power connector 492 may connect to a power source to receive power. Additionally, the at least one power connector 492 may provide power to a battery for charging the battery. The battery may be housed in the material delivery device 400 and may provide power to various components of the material delivery device 400. In aspects, the at least one power connector 492 may connect to the transportation system 600.

Additionally, the material delivery device 400 may be configured for wireless communication. In this regard, the material delivery device 400 may include a transceiver 494 and/or the like. The transceiver 494 of the material delivery device 400 may provide radio and signal processing as needed to access a network and/or the like for services over a communication channel as defined herein. Additionally, the material delivery device 400 may include a processor and the transceiver 494 may be configured to process instruction functions, data transfer, provide other services, transmit the device related information 560 to the controller 502, the data collection system 590 illustrated in FIG. 22, another computer system, and/or the like. In aspects, the material delivery device 400 may implement all the components as described herein, or the material delivery device 400 may implement some of the components as described herein.

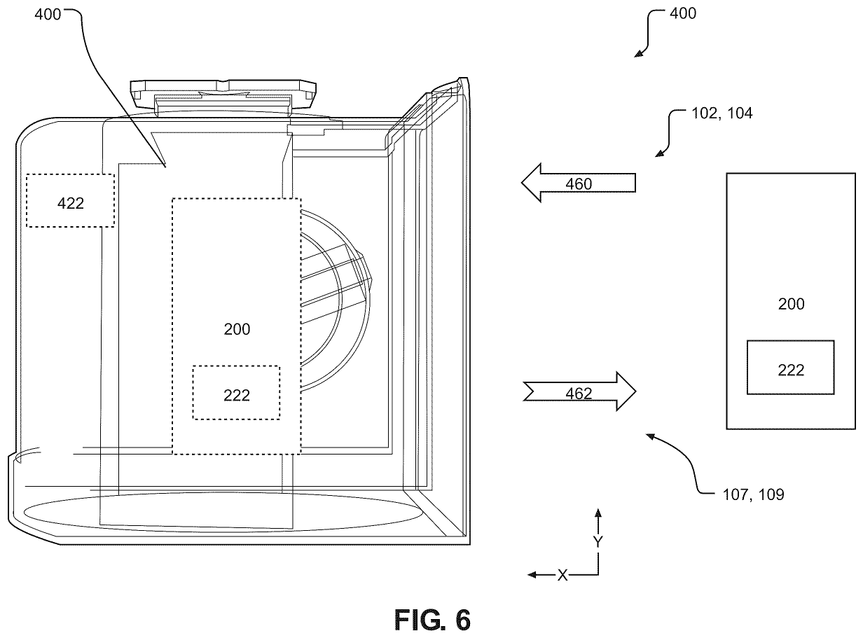

FIG. 6 illustrates a side view of the material delivery device and the service element according to aspects of the disclosure.

In particular, FIG. 6 illustrates loading and/or unloading scenarios of the service element 200 into the material delivery device 400. In aspects, the material delivery device 400 may be configured to receive as illustrated by arrow 460 the service element 200 at the load station 102, the station 107, and/or the like. Additionally, the material delivery device 400 may be configured to deliver as illustrated by arrow 462 the service element 200 at the delivery station 104, the unload station 109, and/or the like. In particular, movement of the service element 200 into and out of the material delivery device 400 may be along the X axis. However, movement of the service element 200 may additionally include movement in other axes as well.

As further illustrated in FIG. 6, the service element 200 may further include a machine-readable code 222. The machine-readable code 222 may be implemented as one or more of a radiofrequency identification (RFID) device, a barcode, a QR code, a Data Matrix (DM) code, and/or the like. In one aspect, the machine-readable code 222 may be a machine-readable code that may be configured to be readable by the machine code reading device 190. In one aspect, the machine-readable code 222 may be an alphanumeric code that may be manually input to a tracking device.

In aspects, the machine code reading device 190 may read the machine-readable code 422 of the material delivery device 400 and the machine-readable code 222 of the service element 200 at the load station 102, the machine code reading device 190 may read the machine-readable code 422 of the material delivery device 400 and the machine-readable code 222 of the service element 200 at the delivery station 104, the machine code reading device 190 may read the machine-readable code 422 of the material delivery device 400 and the machine-readable code 222 of the service element 200 at the transport path 105, the machine code reading device 190 may read the machine-readable code 422 of the material delivery device 400 and the machine-readable code 222 of the service element 200 at the transport path 106, the machine code reading device 190 may read the machine-readable code 422 of the material delivery device 400 and the machine-readable code 222 of the service element 200 at the station 107, the machine code reading device 190 may read the machine-readable code 422 of the material delivery device 400 and the machine-readable code 222 of the service element 200 at the unload station 109, and/or the like.

In aspects, the machine code reading device 190 may read the machine-readable code 422 of the material delivery device 400 and the machine-readable code 222 of the service element 200 and provide data from the machine-readable code 422 and/or the machine-readable code 222 to the controller 502. In this regard, the controller 502 may confirm that the machine-readable code 422 properly identifies a particular implementation of the material delivery device 400. If the controller 502 determines that the material delivery device 400 is incorrect, the controller 502 may provide an error indication, stop operation, and/or the like. Likewise, the controller 502 may confirm that the machine-readable code 222 properly identifies a particular implementation of the service element 200. If the controller 502 determines that the service element 200 is incorrect, the controller 502 may provide an error indication, stop operation, and/or the like.

In one aspect, the machine code reading device 190 may be implemented as a RFID reader configured to generate interrogating radio waves. The interrogating radio waves from the RFID reader may be received by the machine-readable code 422 and/or the machine-readable code 222 implemented as an RFID device. In this aspect, the RFID device may automatically identify the machine-readable code 422 of the material delivery device 400 and/or the machine-readable code 222 of the service element 200 in response to the interrogating radio waves from the RFID reader. The machine-readable code 422 and/or the machine-readable code 222 may contain and transmit electronically-stored information that includes the product related information. In one aspect, the machine-readable code 422 and/or the machine-readable code 222 may collect energy from the RFID reader transmitting interrogating radio waves. In one aspect, the RFID device may have a local power source (such as a battery) and may operate hundreds of meters from the RFID reader.

In one aspect, the machine-readable code 422 and/or the machine-readable code 222 may be implemented as a QR code. In a particular aspect, a camera device may include functionality as a barcode reader or a QR code reader. A QR code (Quick Response Code) is a type of matrix barcode (or two-dimensional barcode). The barcode is a machine-readable optical label that contains information about the material delivery device 400 and/or the service element 200 to which it is attached. A QR code uses a number of standardized encoding modes including numeric, alphanumeric, byte/binary, and the like to efficiently store the product related information. The QR code may include black modules arranged in a square grid on a white background, which can be read by the camera device or other imaging device and processed using Reed-Solomon error correction until the image can be appropriately interpreted. The product related information may then be extracted from patterns that are present in both horizontal and vertical components of the image.

In one aspect, the machine-readable code 422 and/or the machine-readable code 222 may be implemented as a Data Matrix (DM) code. In a particular aspect, the camera device may include functionality as a Data Matrix code reader. A Data Matrix code is a two-dimensional matrix barcode including black and white “cells” or modules arranged in either a square or rectangular pattern. The Data Matrix code may be implemented with the ECC-200 version of Data Matrix and include Reed-Solomon codes for error and erasure recovery. Other protocols and/or versions of Data Matrix are contemplated as well.

FIG. 7 illustrates a cross-sectional top view of the material delivery device according to aspects of the disclosure.

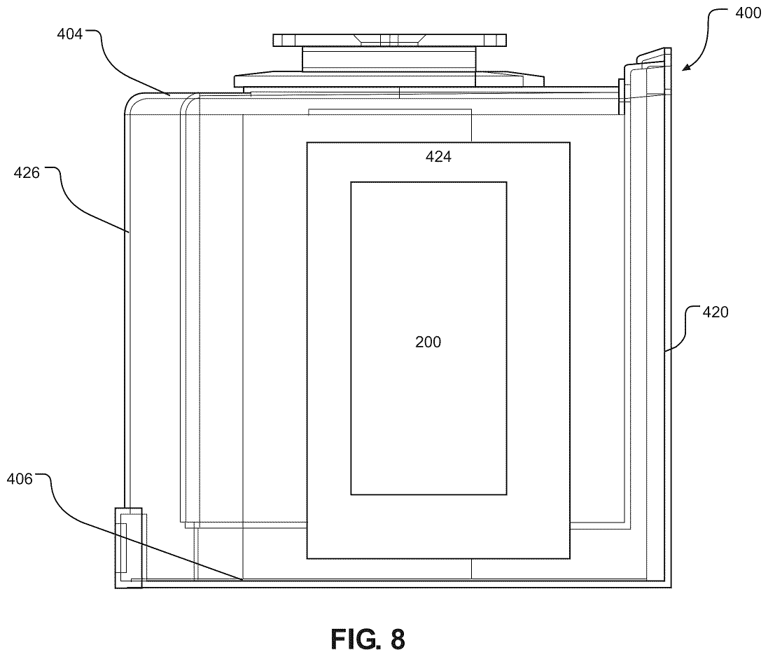

FIG. 8 illustrates a cross-sectional side view of the material delivery device according to aspects of the disclosure.

In particular, FIG. 7 illustrates a cross-sectional view of the material delivery device 400 with the service element 200 loaded within the material delivery device 400. As illustrated in FIG. 7, the material delivery device 400 may further include a holding mechanism 424. In particular aspects, the holding mechanism 424 may be configured to receive, securely hold, and/or the like the service element 200 at the load station 102, the station 107, and/or the like. In particular aspects, the holding mechanism 424 may be configured to securely hold, the service element 200 while being moved by the transportation system 600 along the transport path 103, the transport path 108, and/or the like. In particular aspects, the holding mechanism 424 may be configured to provide the service element 200 at the delivery station 104, the transport path 105, the transport path 106, the dispensing machine 300, and/or the like.

In aspects, the holding mechanism 424 may be implemented as an elastic component, a gripper component, a material component, a friction fit component, a holder component, and/or the like. [*Any others?] In aspects, the holding mechanism 424 may engage a surface of the service element 200, may surround the service element 200, and/or the like.

In aspects, the holding mechanism 424 may engage the service element 200 at a rear surface of the service element 200 adjacent the back wall 426 as illustrated in FIG. 7; in aspects, the holding mechanism 424 may engage the service element 200 at a side surface of the service element 200 adjacent the side walls 402 as illustrated in FIG. 7; in aspects, the holding mechanism 424 may engage the service element 200 at a bottom surface of the service element 200 adjacent the floor 406; in aspects, the holding mechanism 424 may engage the service element 200 at a top surface of the service element 200 adjacent the top wall 404; in aspects, the holding mechanism 424 may engage the service element 200 at a front surface of the service element 200 adjacent the door 420; and/or the like.

In aspects, the holding mechanism 424 may be robustly attached to the material delivery device 400, the interior space 408 of the material delivery device 400 the back wall 426 of the material delivery device 400, the side walls 402 of the material delivery device 400, the floor 406 of the material delivery device 400, the top wall 404 of the material delivery device 400; and/or the like. The attachment of the holding mechanism 424 to the material delivery device 400 may include mechanical fasteners, adhesives, and/or the like.

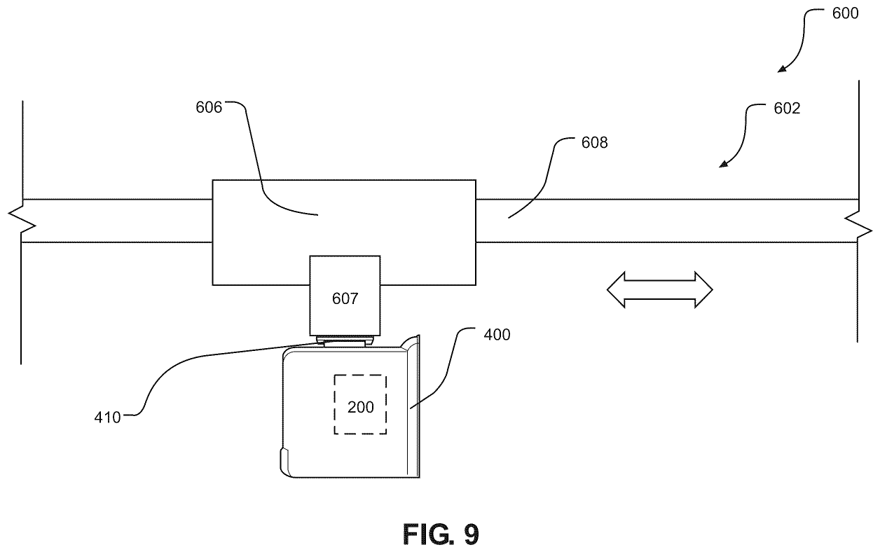

FIG. 9 illustrates an exemplary implementation of the transportation system according to aspects of the disclosure.

In particular, FIG. 9 illustrates the transportation system 600 implemented as a AMHS 602, which may be employed to automatically store and transport the service element 200 and/or the material delivery device 400 within the device manufacturing facility 500. As shown in FIG. 9, the AMHS 602 may include an overhead hoist transport subsystem. The overhead hoist transport subsystem may include a suspended track 608 and a plurality of overhead hoist transport vehicles 606 that may be configured to travel on the suspended track 608 between the load station 102, the delivery station 104, the station 107, the unload station 109 and/or the like within the device manufacturing facility 500. Moreover, a plurality of overhead hoist transport vehicles 606 may be configured to travel along the transport path 108 and/or the transport path 103. In a typical mode of operation, the service element 200 may be transported in the material delivery device 400. The overhead hoist transport vehicles 606 may move along the suspended track 608 and stop at a position suitable for loading and unloading the service element 200 from the material delivery device 400 at the load station 102, the delivery station 104, the station 107, the unload station 109, and/or the like. In the AMHS 602 implementation of the transportation system 600, the material delivery device 400 may be loaded and/or unloaded from the overhead hoist at the load station 102, the delivery station 104, the station 107, the unload station 109, and/or the like by an unloading/loading system 607 that may be configured to engage the connection assembly 410 of the material delivery device 400. In aspects, the unloading/loading system 607 may include movement components such as wires, pulleys, a robot, and/or the like which may provide up to three or more axes of movement. In aspects, the robot may be implemented as the robot 180 illustrated in FIG. 12. The AMHS 602 may include a vision system configured to help identify and locate objects, such as the material delivery device 400 as well as provide guidance for the AMHS 602 and/or the robot.

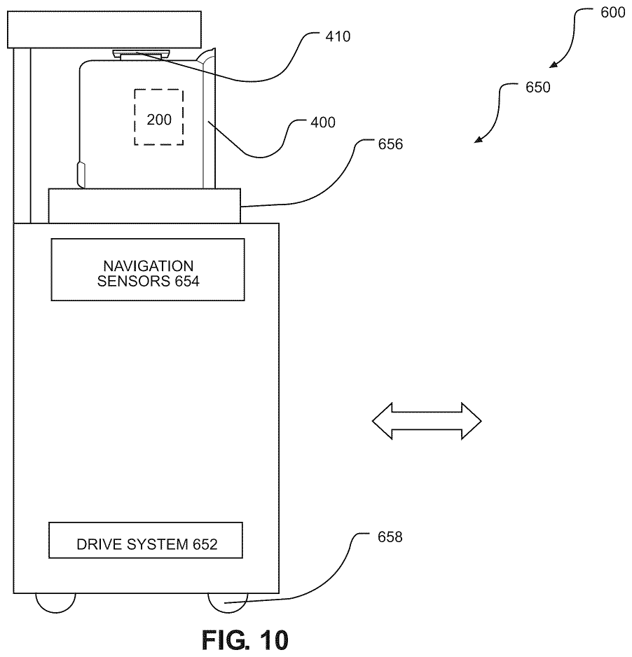

FIG. 10 illustrates another exemplary implementation of the transportation system according to aspects of the disclosure.

In aspects, the transportation system 600 may be implemented as an Automated guided vehicle (AGV) 650. The Automated guided vehicle (AGV) 650 may be configured to load and/or unload the material delivery device 400. The Automated guided vehicle (AGV) 650 may include a drive system 652 with omnidirectional wheels 658, one or more navigation sensors 654 that aid in navigating the Automated guided vehicle (AGV) 650 as well as help avoid obstacles. In one aspect, the navigation sensors 654 may include laser type sensing systems such that the Automated guided vehicle (AGV) 650 is laser directed. The Automated guided vehicle (AGV) 650 may include a loading table or platform 656. The platform 656 may include a vertical transport or lift mechanism that allows the platform 656 to be raised or lowered relative to the drive system 652. The lift mechanism can include hydraulic, pneumatic, and/or electric type lifts. The platform 656 may include a conveyor, which may be in the form of a belt type conveyor, for moving the material delivery device 400, such as for loading, unloading, and/or reorientation. The Automated guided vehicle (AGV) 650 may include a robot. In aspects, the robot may be implemented as the robot 180 illustrated in FIG. 12. The Automated guided vehicle (AGV) 650 may include a vision system configured to help identify and locate objects, such as the material delivery device 400 as well as provide guidance for the Automated guided vehicle (AGV) 650 and/or the robot. Additionally, the robot may include a controller configured to control operation of the various components of the robot. Moreover, the robot may be responsive to the controller 502. In aspects, the Automated guided vehicle (AGV) 650 may be configured for loading and unloading the service element 200 from the material delivery device 400 at the load station 102, the delivery station 104, the station 107, the unload station 109, and/or the like. In aspects, the Automated guided vehicle (AGV) 650 may be configured to engage the connection assembly 410 of the material delivery device 400.

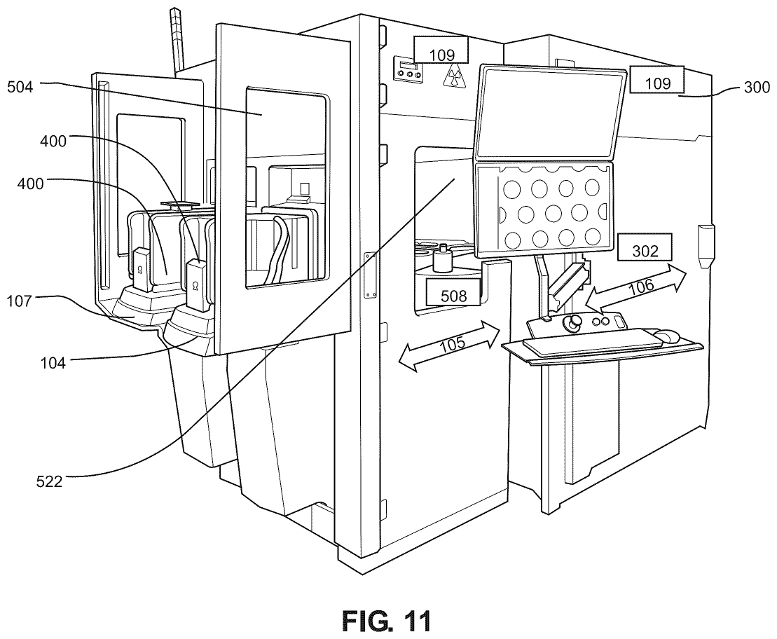

FIG. 11 illustrates an exemplary implementation of the module device and the dispensing machine according to aspects of the disclosure.

In particular, FIG. 11 illustrates an exemplary implementation of the module device 504 that may be implemented as an Equipment Front End Module (EFEM). The module device 504 may include the delivery station 104 and the station 107. As illustrated in FIG. 11, the delivery station 104 includes the material delivery device 400 arranged thereon; and the station 107 includes the material delivery device 400 arranged thereon. Additionally, the module device 504 may include a transport chamber 522 that constitutes a boxed-shaped housing. Additionally, the module device 504 may include an implementation of the machine code reading device 190 operating as described herein. Further, the module device 504 may include a refrigerated compartment to hold the material delivery device 400 and/or the service element 200.

In aspects, the module device 504 may be configured receive the material delivery device 400 from the delivery station 104. Thereafter, the module device 504 may convey the material delivery device 400 and/or the service element 200 along the transport path 105 to the dispensing machine 300. In aspects, the module device 504 may remove the service element 200 from the material delivery device 400 prior to and/or during conveying the service element 200 along the transport path 105 to the dispensing machine 300. In this regard, the module device 504 may include a conveyance system 508 that may be implemented as a conveyor, an automated removal system, a robot, and/or the like to move the material delivery device 400 and/or the service element 200, to remove the service element 200 from the material delivery device 400, and/or the like. In aspects, the robot may be implemented as the robot 180 illustrated in FIG. 12.

In aspects, the module device 504 may be configured receive the material delivery device 400 and/or a consumed portion of the service element 200 from the dispensing machine 300. Thereafter, the module device 504 may convey the material delivery device 400 and/or the service element 200 along the transport path 105 from the dispensing machine 300 toward the station 107. In aspects, the module device 504 may insert the consumed portion of the service element 200 into the material delivery device 400 prior to and/or during conveying the service element 200 along the transport path 105 from the dispensing machine 300. In this regard, the conveyance system 508 may further include a conveyor, an automated insertion system, a robot, and/or the like to move the material delivery device 400 and/or the service element 200, to insert the service element 200 into the material delivery device 400, and/or the like. In aspects, the robot may be implemented as the robot 180 illustrated in FIG. 12.

FIG. 11 further illustrates the dispensing machine 300. In particular, the dispensing machine 300 may be configured to receive the material delivery device 400 and/or the service element 200 from the module device 504. Thereafter, the dispensing machine 300 may convey the material delivery device 400 and/or the service element 200 along the transport path 106 to an operative portion of the dispensing machine 300 that uses the service element 200. In aspects, the service element 200 has been removed from the material delivery device 400 by the module device 504 and the dispensing machine 300 may move the service element 200 along the transport path 106 to the operative portion of the dispensing machine 300. In other aspects, the dispensing machine 300 may remove the service element 200 from the material delivery device 400 prior to and/or during conveying the service element 200 along the transport path 106 to the operative portion of the dispensing machine 300. In this regard, the dispensing machine 300 may include a conveyance system 302 that may include a conveyor, an automated removal system, a robot, and/or the like to move the material delivery device 400 and/or the service element 200, to remove the service element 200 from the material delivery device 400, to move the service element 200 to the operative portion of the dispensing machine 300 and/or the like. In aspects, the robot may be implemented as the robot 180 illustrated in FIG. 12.

In aspects, the dispensing machine 300 may additionally utilize the conveyance system 302 to remove a consumed portion of the service element 200 from the operative portion of the dispensing machine 300, transport the consumed portion of the service element 200 along the transport path 106 to the module device 504. In other aspects, the dispensing machine 300 may insert the consumed portion of the service element 200 into the material delivery device 400 prior to and/or during conveying the service element 200 along the transport path 106 to the module device 504.

FIG. 12 illustrates an exemplary implementation of a robot implemented by a number of different components of the disclosure.

In particular, FIG. 12 illustrates the robot 180 that may be implemented by a number of different components of the system for automated material delivery 100, the dispensing machine 300, the module device 504, the transportation system 600, and/or the like. In aspects, the robot 180 may include one or more arms 182, one or more motors to move the one or more arms 182, which may provide up to three or more axes of movement. Additionally, the one or more arms 182 may include one or more suction cups, manipulators 184, and/or the like for grasping, moving, and/or the like the service element 200 and/or the material delivery device 400. Additionally, the robot 180 may include a controller configured to control operation of the various components of the robot. Moreover, the robot may be responsive to the controller 502. The robot 180 may include a vision system configured to help identify and locate objects, such as the material delivery device 400.

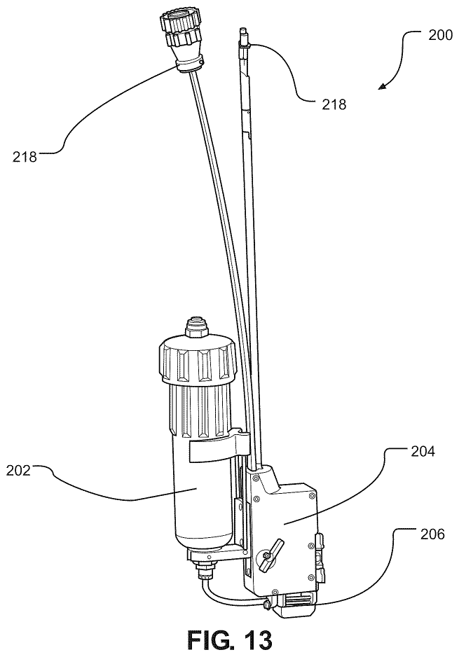

FIG. 13 illustrates a side view of an exemplary implementation of the service element according to aspects of the disclosure.

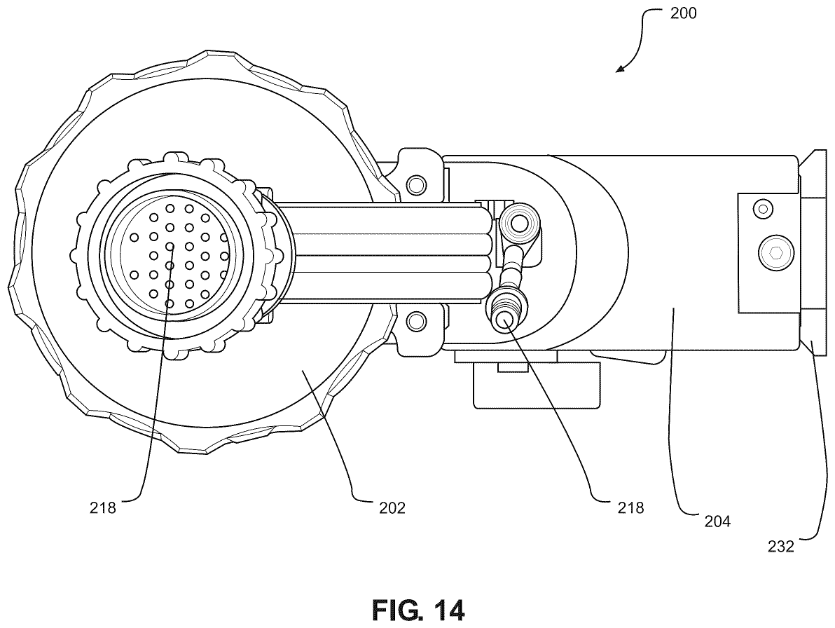

FIG. 14 illustrates a top view of an exemplary implementation of the service element according to FIG. 13.

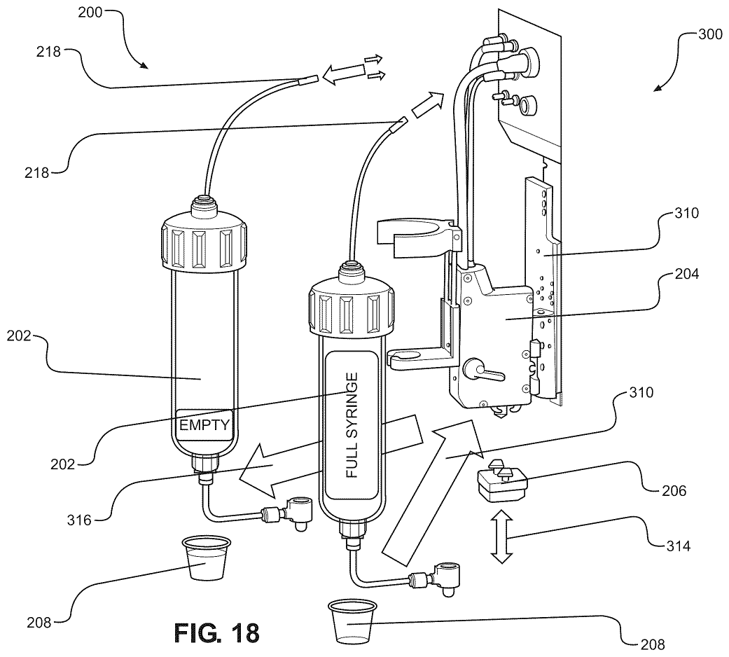

In particular, FIG. 13 illustrates an implementation of the service element 200 that may include a syringe of material 202, a dispenser valve 204, and a dispenser cartridge 206. The dispenser valve 204 may include connections 218 operative to provide and/or receive electrical signals, electrical power, data, air for pneumatic operation, and/or the like. In aspects, the service element 200 may include all, some, or one of the syringe of material 202, the dispenser valve 204, and the dispenser cartridge 206. In further aspects, the service element 200 may include a dispenser cup 208 as illustrated in FIG. 18. In further aspects, the dispenser valve 204 may include an attachment bracket 232 as illustrated in FIG. 14. The attachment bracket 232 may be configured to attach to an operative portion of the dispensing machine 300. In this regard, the dispensing machine 300 may consume various materials including the service element 200, such as the syringe of material 202, the dispenser valve 204, the dispenser cartridge 206, the dispenser cup 208, and/or the like. In aspects, the service element 200 may include one or more of the syringe of material 202, the dispenser valve 204, the dispenser cartridge 206, the dispenser cup 208, and/or the like combined in a unit to form a servicing package or servicing station for the dispensing machine 300.

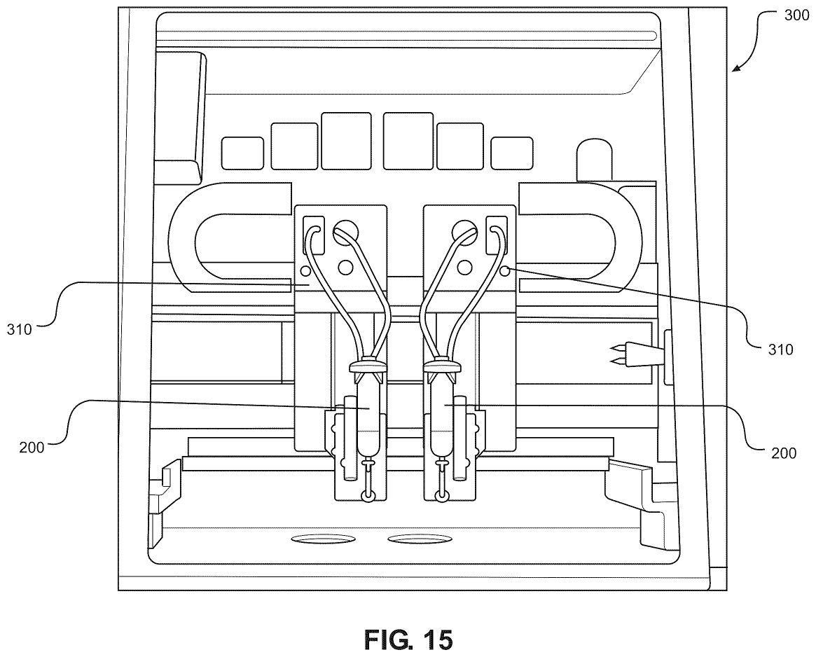

FIG. 15 illustrates a partial side view of the dispensing machine according to aspects of the disclosure.

In particular, FIG. 15 illustrates a partial side view of the dispensing machine 300 with the service element 200 arranged on an operative portion 310 of the dispensing machine 300. In this regard, FIG. 15 illustrates two implementations of the operative portion 310 each holding two different implementations of the service element 200. However, the dispensing machine 300 may include any number of the operative portion 310, the service element 200, and/or the like.

The dispensing machine 300 may be configured to dispense a fluid from the syringe of material 202 through the dispenser cartridge 206 by a controlled operation of the dispenser valve 204. In this regard, the dispensing machine 300 may hold the syringe of material 202, the dispenser valve 204, the dispenser cartridge 206, and/or the like on the operative portion 310. Moreover, the connections 218 may connect to the operative portion 310 in order to provide actuation of the dispenser valve 204. The dispensing machine 300 may be configured to dispense fluid from the syringe of material 202 onto a substrate. Additionally, at times the dispensing machine 300 may be configured to dispense fluid from the syringe of material 202 into the dispenser cup 208. However, the service element 200 is consumable and after some given amount of time, the service element 200 must be replaced within the dispensing machine 300. Additionally, at times, one or more components of the service element 200 may fail and likewise must be replaced within the dispensing machine 300.

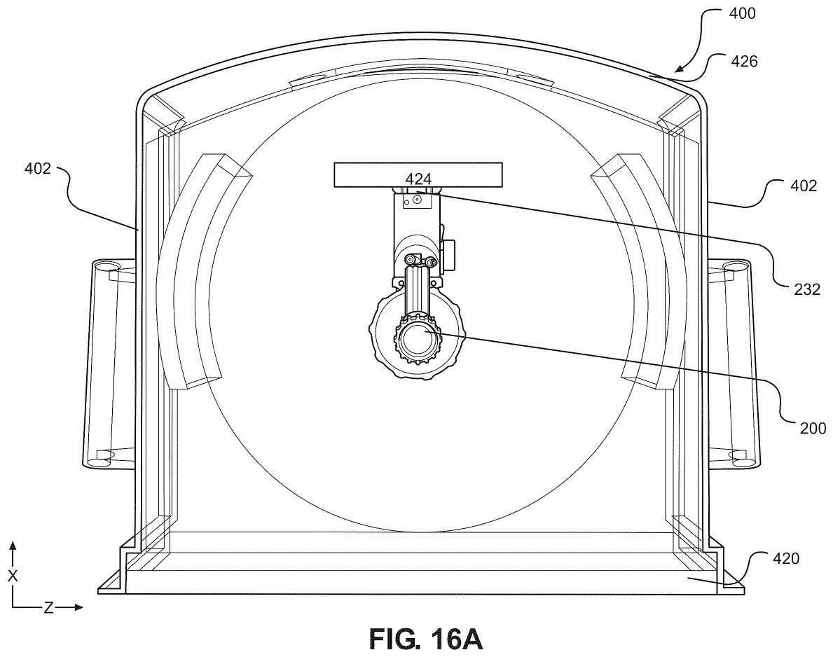

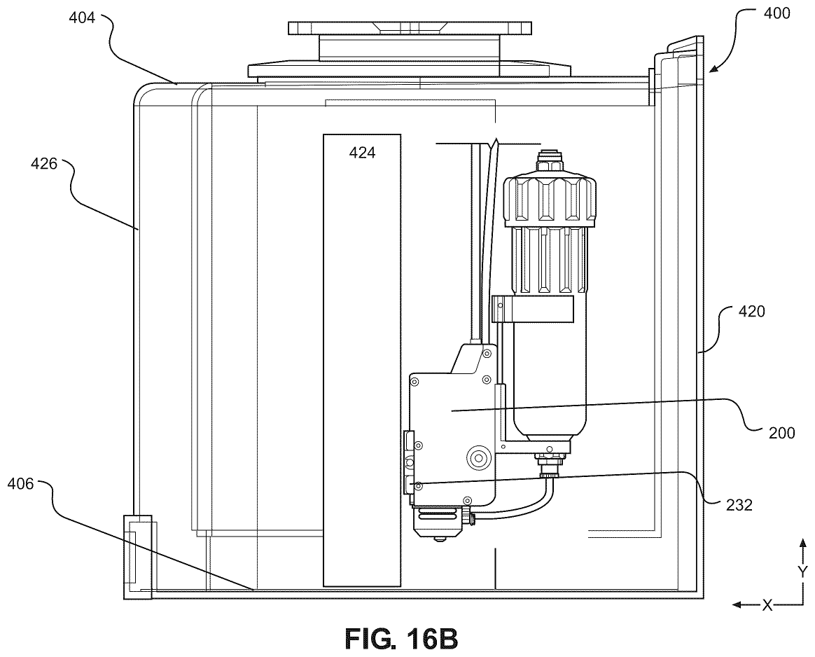

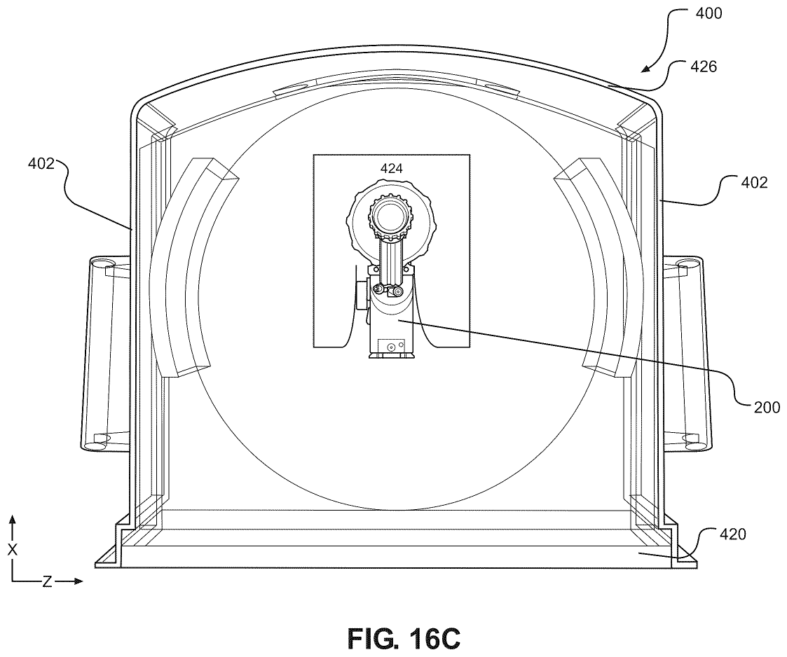

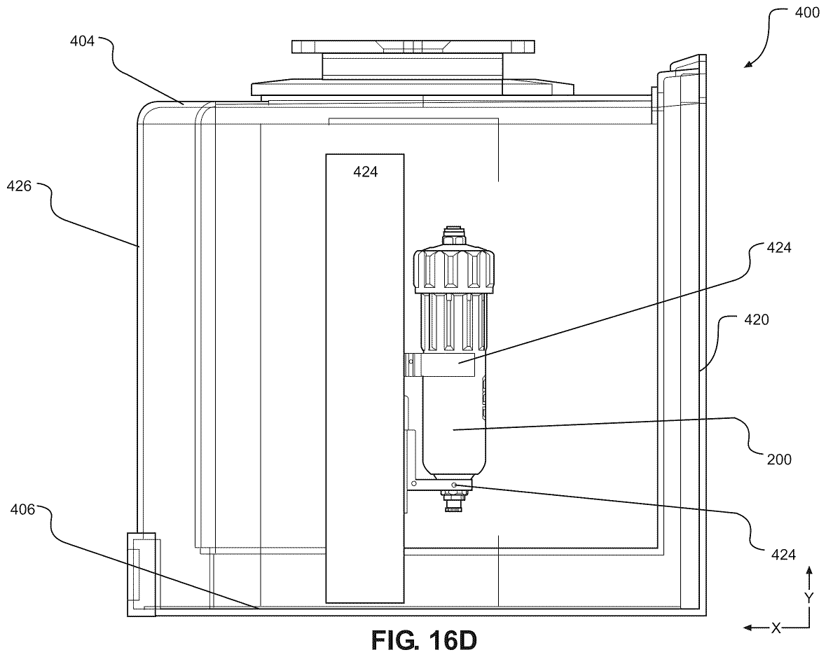

FIG. 16A illustrates a cross-sectional top view of the material delivery device and the service element according to aspects of the disclosure.

FIG. 16B illustrates a cross-sectional side view of the material delivery device and the service element according to FIG. 16A.

In particular, FIG. 16A and FIG. 16B illustrate the material delivery device 400 with the service element 200 of FIG. 14 loaded within the material delivery device 400. As illustrated in FIG. 16A, the material delivery device 400 may further include the holding mechanism 424 holding the service element 200. In particular, the holding mechanism 424 may attach to the attachment bracket 232 of the service element 200. The attachment of the attachment bracket 232 of the service element 200 to the holding mechanism 424 may be by mechanical fasteners, clips, brackets, and/or the like.

FIG. 16C illustrates a cross-sectional top view of the material delivery device and the service element according to aspects of the disclosure.

In particular, FIG. 16C illustrates the material delivery device 400 with the service element 200 of FIG. 14 loaded within the material delivery device 400. As illustrated in FIG. 16C, the material delivery device 400 may further include the holding mechanism 424 holding the service element 200. In particular, the holding mechanism 424 may surround portions of the service element 200. In this regard, the holding mechanism 424 may be configured as a deformable material.

FIG. 16D illustrates a cross-sectional side view of the material delivery device and the service element according to aspects of the disclosure.

In particular, FIG. 16D illustrates the material delivery device 400 with the service element 200 of FIG. 14 loaded within the material delivery device 400. As illustrated in FIG. 16D, the material delivery device 400 may further include the holding mechanism 424 holding the service element 200. In particular, the holding mechanism 424 may surround portions of the service element 200. In this regard, the holding mechanism 424 may be configured as one or more brackets that engage sides of the service element 200 and/or a bottom of the service element 200.

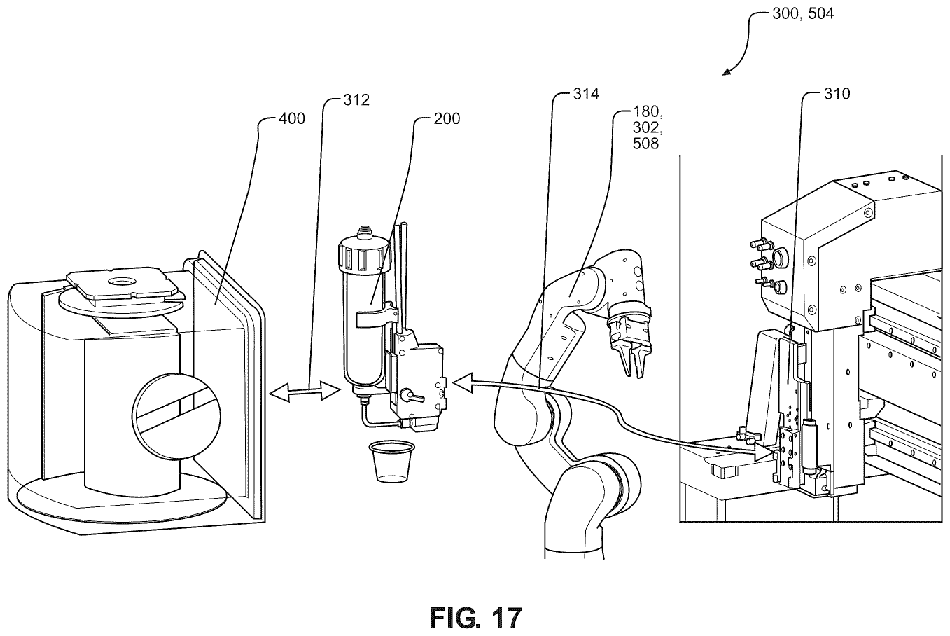

FIG. 17 illustrates exemplary exchange operations according to aspects of the disclosure.

In particular, FIG. 17 illustrates a process of the material delivery device 400 delivering the service element 200 to the dispensing machine 300. More specifically, the material delivery device 400 may deliver the service element 200 to the dispensing machine 300 and/or the module device 504 as previously described. Thereafter, in aspects the conveyance system 508 and/or the robot 180 of the module device 504 may remove the service element 200 from the material delivery device 400 as shown by arrow 312. In other aspects, the conveyance system 302 and/or the robot 180 of the dispensing machine 300 may remove the service element 200 from the material delivery device 400 as shown by the arrow 312. Once the service element 200 has been removed from the material delivery device 400, the service element 200 may be conveyed to the operative portion 310 of the dispensing machine 300 as shown by the arrow 314. Thereafter, the conveyance system 302 and/or the robot 180 of the dispensing machine 300 may arrange the service element 200 onto the operative portion 310 of the dispensing machine 300 as further shown by the arrow 314. In aspects, the conveyance system 302 and/or the robot 180 of the dispensing machine 300 may be further configured to connect the service element 200 to the operative portion 310 of the dispensing machine 300.

FIG. 18 illustrates further exemplary exchange operations according to aspects of the disclosure.

In particular, FIG. 18 illustrates a process of delivering the service element 200 to the dispensing machine 300. In this regard, the service element 200 may include the syringe of material 202, the dispenser cartridge 206, and the dispenser cup 208. Accordingly, the dispenser valve 204 may stay connected to the operative portion 310 of the dispensing machine 300. More specifically, FIG. 18 illustrates that the conveyance system 302 and/or the robot 180 of the dispensing machine 300 may remove consumed implementations of the syringe of material 202, the dispenser cartridge 206, and/or the like from the operative portion 310 of the dispensing machine 300 as illustrated by arrow 316. Additionally, the conveyance system 302 and/or the robot 180 of the dispensing machine 300 may remove consumed implementations of the dispenser cup 208 from the dispensing machine 300. In this regard, the syringe of material 202 is now empty and no longer usable by the dispensing machine 300 and the dispenser cup 208 is now for full and no longer usable by the dispensing machine 300. Moreover, the conveyance system 302 and/or the robot 180 may disconnect the connections 218 of the service element 200 from the operative portion 310.

With further reference to FIG. 18, the conveyance system 302 and/or the robot 180 may now load a full implementation of the syringe of material 202 and a fresh implementation of the dispenser cartridge 206 into the dispensing machine 300 by attachment to the operative portion 310. Additionally, the conveyance system 302 and/or the robot 180 may now load an empty implementation of the dispenser cup 208 into the dispensing machine 300. Additionally, the conveyance system 302 and/or the robot 180 may connect the connections 218 of the service element 200 to the operative portion 310 of the dispensing machine 300.

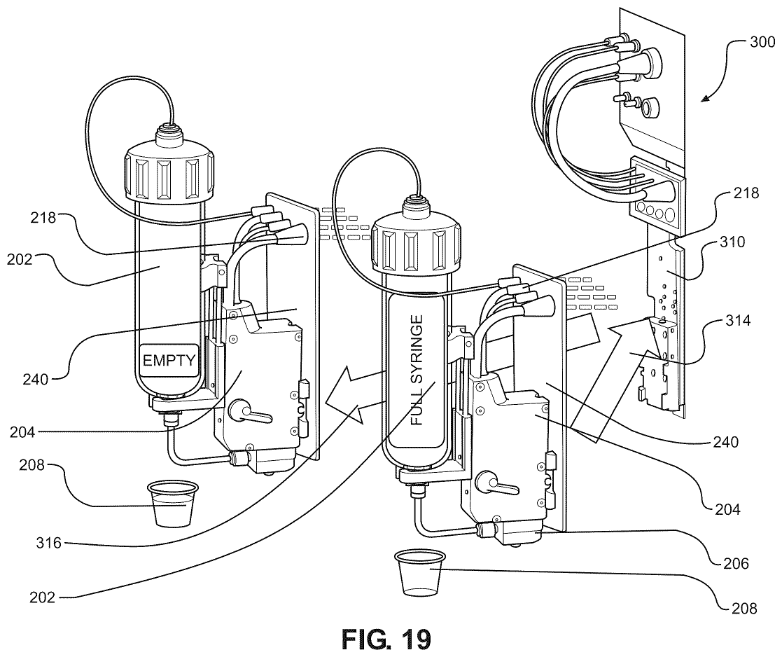

FIG. 19 illustrates further exemplary exchange operations according to aspects of the disclosure.

In particular, FIG. 19 illustrates a process of delivering the service element 200 to the dispensing machine 300. In this regard, the service element 200 may further include an attachment plate 240. Various components of the service element 200 may be attached to the attachment plate 240 including the syringe of material 202, the dispenser valve 204, the dispenser cartridge 206, and the connections 218. The attachment plate 240 may include connections from the connections 218 to corresponding connections of the operative portion 310 of the dispensing machine 300.

In aspects, the conveyance system 302 and/or the robot 180 of the dispensing machine 300 may remove an empty implementation of the syringe of material 202, a used implementation of the dispenser valve 204, and a used implementation of the dispenser cartridge 206 from the dispensing machine 300 by removal of the attachment plate 240 of the service element 200 from the operative portion 310 of the dispensing machine 300. Additionally, the conveyance system 302 and/or the robot 180 of the dispensing machine 300 may now load a full implementation of the syringe of material 202, a fresh implementation of the dispenser valve 204, and a fresh implementation of the dispenser cartridge 206 into the dispensing machine 300 by attachment of the attachment plate 240 to the operative portion 310 the dispensing machine 300.

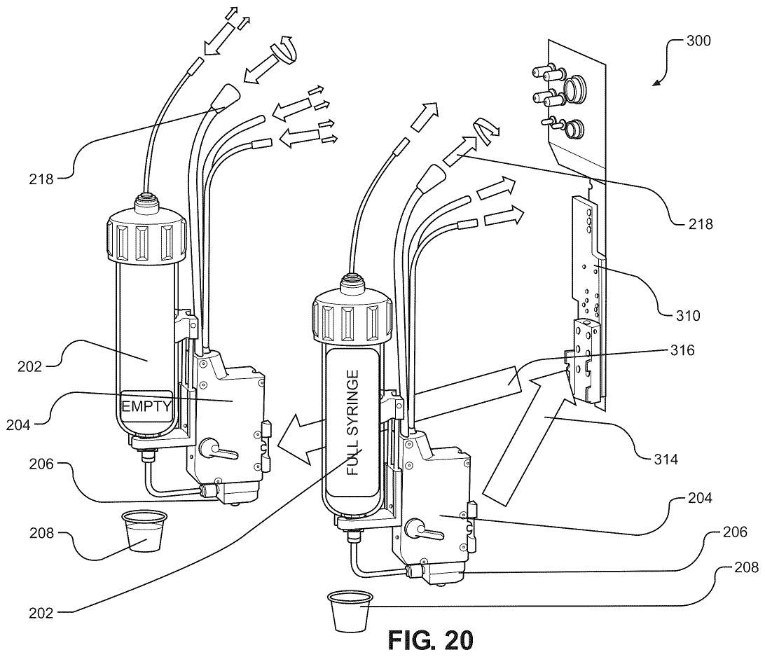

FIG. 20 illustrates further exemplary exchange operations according to aspects of the disclosure.

In particular, FIG. 20 illustrates a process of delivering the service element 200 to the dispensing machine 300. In this regard, the service element 200 may include the syringe of material 202, the dispenser cartridge 206, the dispenser valve 204, and the dispenser cup 208. More specifically, FIG. 20 illustrates that the conveyance system 302 and/or the robot 180 of the dispensing machine 300 may remove consumed implementations of the syringe of material 202, the dispenser cartridge 206, the dispenser valve 204 and/or the like from the operative portion 310 of the dispensing machine 300 as illustrated by arrow 316. Additionally, the conveyance system 302 and/or the robot 180 of the dispensing machine 300 may remove consumed implementations of the dispenser cup 208 from the dispensing machine 300. In this regard, the syringe of material 202 is now empty and no longer usable by the dispensing machine 300 and the dispenser cup 208 is now for full and no longer usable by the dispensing machine 300. Additionally, the dispenser valve 204 and the dispenser cartridge 206 may need replacement as well. Moreover, the conveyance system 302 and/or the robot 180 may disconnect the connections 218 of the service element 200 from the operative portion 310. In this regard, the connections 218 may be implemented as twist on connections, push on connections, and/or the like.

With further reference to FIG. 20, the conveyance system 302 and/or the robot 180 may now load a full implementation of the syringe of material 202 and a fresh implementations of the dispenser cartridge 206 and the dispenser valve 204 into the dispensing machine 300 by attachment to the operative portion 310. Additionally, the conveyance system 302 and/or the robot 180 may now load an empty implementation of the dispenser cup 208 into the dispensing machine 300. Additionally, the conveyance system 302 and/or the robot 180 may connect the connections 218 of the service element 200 to the operative portion 310 of the dispensing machine 300.

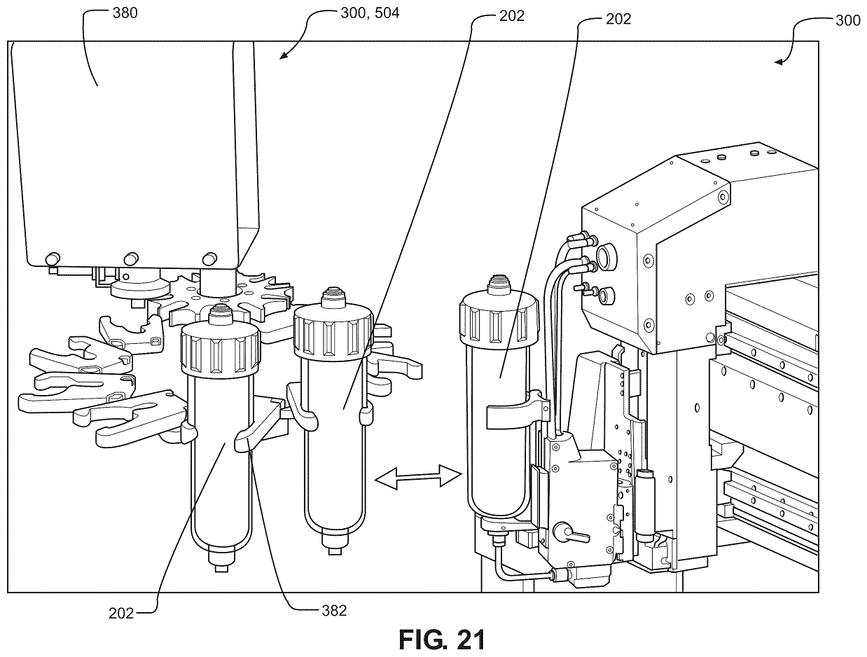

FIG. 21 illustrates another implementation of the module device and/or the dispensing machine according to aspects of the disclosure.

In particular, FIG. 21 illustrates another implementation of the module device 504 and/or the dispensing machine 300 that may include a turret style tool changer 380. The turret style tool changer 380 may be located in the module device 504 and/or the dispensing machine 300. The turret style tool changer 380 may be configured for exchanging quick disconnect implementations of the syringe of material 202. The syringe of material 202 may be delivered by the material delivery device 400 as described herein. The turret style tool changer 380 may be configured to hold a plurality of implementations of the service element 200, such as the syringe of material 202 illustrated in FIG. 21. In this regard, the turret style tool changer 380 may include a plurality of attachment portions 382 configured to engage and hold one or more components of the service element 200. As illustrated in FIG. 21, the plurality of attachment portions 382 are holding a plurality of the syringe of material 202. The turret style tool changer 380 may be configured with a motor responsive to the controller 502 to rotate and present a desired one of the plurality of attachment portions 382 for receiving a consumed portion of the service element 200 and/or present a desired one of the plurality of attachment portions 382 for delivering a fresh portion of the service element 200. In aspects, the conveyance system 508 and/or the robot 180 of the module device 504 may convey the service element 200 to the dispensing machine 300. In aspects, the dispensing machine 300 to and/or the robot 180 of the dispensing machine 300 may convey the service element 200 received from the turret style tool changer 380 to the operative portion 310 of the dispensing machine 300. In this regard, the turret style tool changer 380 may store and/or provide a plurality of the service element 200 locally to the module device 504 and/or the dispensing machine 300. In aspects, the turret style tool changer 380 may be located in the refrigerated compartment of the module device 504.

FIG. 22 illustrates a data collection system according to the principles of the disclosure.

In aspects, the system for automated material delivery 100 may be configured to provide automated material delivery, automated material changeover, automated setup & calibration, and/or the like as described above. Additionally, the system for automated material delivery 100 may be configured to provide automated process control, automated error prediction & recovery, and/or the like for one or more components of the device manufacturing facility 500 including the service element 200, the dispensing machine 300, the material delivery device 400, and/or the like. In aspects, the system for automated material delivery 100 may be configured to provide Data Analytics and Traceability to support increasing data traceability and analytics for one or more components of the device manufacturing facility 500 including the service element 200, the dispensing machine 300, the material delivery device 400, and/or the like. In aspects, the system for automated material delivery 100 may implement an application programming interface (API) used to enable communications as well as an independent operation of one or more components of the device manufacturing facility 500 including the service element 200, the dispensing machine 300, the material delivery device 400, and/or the like. The system for automated material delivery 100 in conjunction with the controller 502 may provide remote access to equipment, reporting and centralized control over a production floor of the device manufacturing facility 500 from a remote office for one or more components of the device manufacturing facility 500 including the service element 200, the dispensing machine 300, the material delivery device 400, and/or the like.

Additionally, the system for automated material delivery 100 may be configured to take all process information currently available on the various machines implemented by the system for automated material delivery 100, such as sensor data, alarm states, commanded operations, and/or the like as well as any new sources of dispense metrics, determine which are relevant to production health, and use those to create automated process control routines to keep production running as smoothly and long as possible. This process may involve standard control routines that change settings to meet performance specifications, utilize machine learning applications to classify normal vs abnormal dispensing states, with accompanying process control algorithms to adjust settings as necessary. Additionally, the system for automated material delivery 100 may implement automated process control that may focus on looking at recorded sensor data to predict, recognize, and recover from common alarms and error states with minimal operator intervention. Further, the system for automated material delivery 100 may be configured such that if an automatic resolution is not possible, then an “expert system” or flowchart style interface could be deployed to assist a remote operator or field service technician in identifying root causes and best known methods of bringing the process tool of the system for automated material delivery 100 back online as quickly as possible. Additionally, the system for automated material delivery 100 may be configured such that control of the various machines of the system for automated material delivery 100 and any data that is gathered during production can be easily and effectively shared with a remote operator via a data infrastructure. Further, the system for automated material delivery 100 may be configured for machine learning or digital twin applications to exist, with data streaming in from production for training, testing, and analysis. Moreover, operation of the system for automated material delivery 100 may be configured such that all operator interaction with the various machines of the system for automated material delivery 100 and data from the system for automated material delivery 100 may be done via this remote connection.

In particular, as illustrated in FIG. 22 one or more of the above-noted aspects may be implemented with a data collection system 590. In aspects, the data collection system 590 may be implemented as part of the controller 502. In aspects, the data collection system 590 may be implemented separate from the controller 502. The data collection system 590 may be implemented by one or more servers, processors 576, databases 592, network interfaces 510, input output devices 566, memory 588, and the like.

In aspects, the data collection system 590 may receive, analyze, store, and provide the device related information 560 related to the system for automated material delivery 100, the service element 200, the dispensing machine 300, the device manufacturing facility 500, the controller 502, the module device 504, the transportation system 600, components thereof, and/or the like. The device related information 560 may include date and time of particular operations date and time of dispense, machine serial number, pressures, temperatures, scripted offset data, dispense settings, dispense metrics, valve serial number, cycles, calibration data, encoder traces, cartridge serial number, cycles, consumable life, fluid lot number, pot life, syringe level, wafer serial number, and/or the like.

In one aspect, the data collection system 590 may be configured as centralized computer. In one aspect, the data collection system 590 may be configured as a server. In one aspect, the data collection system 590 may be configured as a decentralized server. In one aspect, the data collection system 590 may be configured as a decentralized computer. In one aspect, the data collection system 590 may be configured to communicate over a network utilizing encryption; and the data collection system 590 may be configured for decryption of data received over the network. The processor 576 and/or the network interface 510 may provide the encryption and decryption functionality.

Additionally, the various components of the system for automated material delivery 100 as described herein may likewise be configured for and provide the encryption and decryption functionality as described herein. In one aspect, the encryption may include a process of encoding a message, information, the product related information, and/or the like in such a way that only authorized parties can access it and those who are not authorized cannot. In one aspect, the encryption may include an encryption scheme, the intended information or message, referred to as plaintext, is encrypted using an encryption algorithm, which may be a cipher, generating ciphertext that can be read only if decrypted. In one aspect, the encryption scheme may use a pseudo-random encryption key generated by an algorithm. In symmetric-key schemes, the encryption and decryption keys may be the same. Communicating parties must have the same key in order to achieve secure communication. In one aspect, the encryption scheme may be a public-key encryption scheme where the encryption key is published for anyone to use and encrypt messages. However, only the receiving party has access to the decryption key that enables messages to be read.

In one aspect, the data collection system 590 may be configured as cloud-based system. In one aspect, the data collection system 590 may be configured as non-cloud-based system. In one aspect, the data collection system 590 may be configured as a transformation services layer, micro services, and/or the like and equivalents thereof.

In one aspect, the data collection system 590 may be configured to store in the database 592 all the above noted device related information 560 from the system for automated material delivery 100, the service element 200, the dispensing machine 300, the device manufacturing facility 500, the controller 502, the module device 504, the transportation system 600, components thereof, and/or the like. In this regard, the data collection system 590 may be configured to connect directly to a computer 580 or connect over the network to the computer 580 in order to provide the stored device related information 560 from the database 592.

In particular aspects, the data collection system 590 in response to a query from the computer 580 may be configured to allow searching for any of the above noted captured information that includes the device related information 560 obtained from the various components of the system for automated material delivery 100, the service element 200, the dispensing machine 300, the device manufacturing facility 500, the controller 502, the module device 504, the transportation system 600, components thereof, and/or the like. In this regard, the query to the data collection system 590 may include a query for a particular device of the system for automated material delivery 100 and the data collection system 590 in conjunction with the database 592 may obtain and transmit the response to the computer 580. In particular, the query can be based on the particular device of the system for automated material delivery 100, a particular one of the device manufacturing facility 500, a particular aspect of the device related information 560, and/or the like.

In particular aspects, the data collection system 590 in response to a query from the computer 580 may be configured to provide information related to the device related information 560 as well as inventory determination, replacement determination, supply chain determination, consumption metrics, inventory counts, gross inventory, forecasted inventory, and the like based on the above noted captured information that includes the device related information 560 obtained from the various components of the system for automated material delivery 100 as described herein. In this regard, the query to the data collection system 590 may include a query for the inventory related information and the data collection system 590 in conjunction with the database 592 may obtain and transmit the response to the computer 580.

In some aspects, the data collection system 590 may be configured with artificial intelligence in order to assist in the analysis the device related information 560. The artificial intelligence may utilize any number of approaches including one or more of cybernetics and brain simulation, symbolic, cognitive simulation, logic-based, anti-logic, knowledge-based, sub-symbolic, embodied intelligence, computational intelligence and soft computing, machine learning and statistics, and the like in order to assist in the inventory analysis.

In particular aspects, the data collection system 590 in response to a query from the computer 580 may be configured to provide traceability functions based on the above noted captured information that includes the device related information 560 obtained from the system for automated material delivery 100, the controller 502, and/or the like. In this regard, the query to the data collection system 590 may include a query for tracing a particular one or more of the devices of the system for automated material delivery 100 and the data collection system 590 in conjunction with the database 592 may obtain and transmit the response to the computer 580. In particular, the traceability functionality query can be based on the device related information 560, the particular device of the system for automated material delivery 100, by case number, by lot number, by batch number, by item number, and/or the like.

In particular aspects, the data collection system 590 in response to a query from the computer 580 may be configured to provide for tracking functions based on the above noted captured information that includes the device related information 560 obtained from the system for automated material delivery 100 and/or the controller 502. In this regard, the query to the data collection system 590 may include a query for tracking a particular aspect of the device related information 560 and the data collection system 590 in conjunction with the database 592 may obtain and transmit the response to the computer 580. In particular, the tracking functionality query can be based on the particular aspect of the device related information 560, the particular device of the system for automated material delivery 100, a particular one of the device manufacturing facility 500, by case number, by lot number, by batch number, by item number, serial number and/or the like.

In some aspects, the data collection system 590, the various components of the system for automated material delivery 100 as described herein, and/or the like may be configured with artificial intelligence in order to assist in the determination of a pathogen, disease, and/or the like. The artificial intelligence may utilize any number of approaches including one or more of cybernetics and brain simulation, symbolic, cognitive simulation, logic-based, anti-logic, knowledge-based, sub-symbolic, embodied intelligence, computational intelligence and soft computing, machine learning and statistics, and the like in order to assist in the determination of a pathogen, disease, and/or the like.

In particular aspects, the data collection system 590 and/or the database 592 may utilize and implement blockchain 512 technology. In this regard, the data collection system 590 and/or the database 592 may take the received device related information 560 as a list of records, that may be defined as blocks. In particular, each of the blocks of the device related information 560 may be linked using cryptography. Each block may contain a cryptographic hash of the previous block, a timestamp, and the device related information 560. The blockchain 512 may be managed by the data collection system 590 adhering to a protocol for inter-node communication and validation of new blocks. In some aspects, the resulting blockchain 512 of the device related information 560 may form a blockchain ledger that may not be easily modified, changed, and the like to ensure a higher level of security and data confidence. In one aspect, the block chain 512 may be implemented as a public blockchain, a private blockchain, a consortium blockchain, and/or the like.

In one aspect, the data collection system 590 may include a functional application programming interface (API) system 550. In one aspect, the data collection system 590 may include a management application programming interface (API) system 552. In one aspect, the data collection system 590 may include the management application programming interface (API) system 552 and the functional application programming interface (API) system 550.

In some aspects, the APIs of the functional application programming interface (API) system 550 and the management application programming interface (API) system 552 may include a set of subroutine definitions, protocols, tools, and the like. These may include a set of clearly defined methods of communication between various software components including the and the data collection system 590. The APIs may be for a web-based system, an operating system, a database system, computer hardware, a software library, and/or the like. In some aspects, the APIs may include a specification that can take many forms, but may include specifications for routines, data structures, object classes, variables, remote calls, and/or the like. The APIs may be implemented by POSIX, Windows API, ASPI, and the like.

The functional application programming interface (API) system 550 may implement or connect to an on-demand cloud computing platform. The functional application programming interface (API) system 550 may allow subscribers to have at their disposal a full-fledged virtual cluster of computers, available all the time, through the internet. The functional application programming interface (API) system 550 may implement virtual computers that may include a number of the attributes of a real computer including a central processing unit (CPU), graphics processing unit (GPU), Random-access memory (RAM), hard-disk storage, solid-state drive (SSD) storage, and/or the like. The functional application programming interface (API) system 550 may include a choice of operating systems and networking. The functional application programming interface (API) system 550 may have pre-loaded application software such as web servers, databases, and the like. The functional application programming interface (API) system 550 may also virtualize its console I/O (keyboard, display, and mouse), allowing users to connect to the data collection system 590 using a browser, and/or the like. The browser may act as a window into the virtual computer, letting subscribers log-in, configure, and the like.

In some aspects of the disclosure, one or more of the management application programming interface (API) system 552 and/or the data collection system 590 may include an information portal, query portal, and/or the like that may be implemented as a web portal. The information portal may be a specially designed portal that brings information from diverse sources including the system for automated material delivery 100 and/or the data collection system 590. In some aspects, each information source may receive a dedicated area on a page for displaying information (a portlet). In some aspects, the portal may include mashups and intranet “dashboards.” The portal may use the application programming interface (API). The portal may provide a way for enterprises and organizations with access control, modification, procedures, and the like for the data collection system 590, and/or the like. The features available may be restricted to an authorized and authenticated user (employee, member).

In one or more aspects, the management application programming interface (API) system 552 and/or the functional application programming interface (API) system 550 may be configured to run commands for the various components of the system for automated material delivery 100 as described herein, the data collection system 590, and/or the like on Windows, macOS, Linux, and/or the like. These commands may allow the creation and management of the various components of the system for automated material delivery 100 as described herein, the data collection system 590, certificates, rules, and policies. In one or more aspects, the management application programming interface (API) system 552 and/or the functional application programming interface (API) system 550 may be configured to build IoT applications for the system for automated material delivery 100 using HTTP or HTTPS requests. These API actions allow the program creation and management of the system for automated material delivery 100, certificates, rules, and policies. In one or more aspects, the management application programming interface (API) system 552 and/or the functional application programming interface (API) system 550 may be configured to build IoT applications using language-specific APIs. The associated SDKs may wrap the HTTP/HTTPS API and allow programming in any of the supported languages. In one or more aspects, the management application programming interface (API) system 552 and/or the functional application programming interface (API) system 550 may be configured to build applications that run on the various components of the system for automated material delivery 100 as described herein, the data collection system 590, and the like that send messages to and receive messages from the management application programming interface (API) system 552, the functional application programming interface (API) system 550, and/or the various components of the system for automated material delivery 100 as described herein.

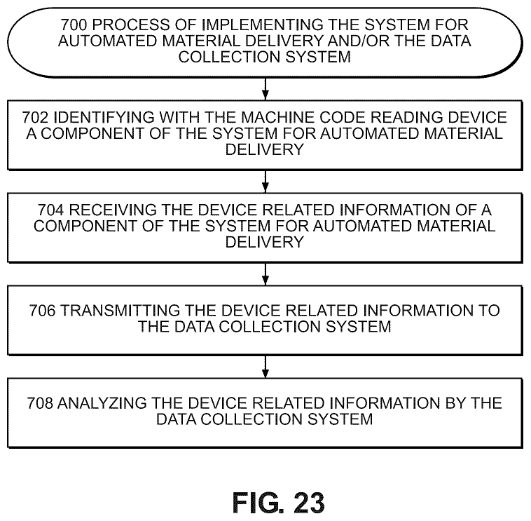

FIG. 23 illustrates a process of implementing the system for automated material delivery and/or the data collection system according to principles of the disclosure.

In particular, FIG. 23 illustrates a process of implementing the system for automated material delivery and/or the data collection system 700 that comprises a process of implementing the system for automated material delivery 100 and/or the data collection system 590 as described herein. The process of implementing the system for automated material delivery and/or the data collection system 700 may include identifying with the machine code reading device a component of the system for automated material delivery 702. In particular, the identifying with the machine code reading device a component of the system for automated material delivery 702 may include identifying with the machine code reading device 190 a component of the system for automated material delivery 100 as described herein, such as components of the service element 200, the dispensing machine 300, the material delivery device 400, and/or the like. In this regard, the identification may include reading the machine-readable code 422 and/or the machine-readable code 222 with the machine code reading device 190.

Additionally, the process of implementing the system for automated material delivery and/or the data collection system 700 may include receiving the device related information of a component of the system for automated material delivery 704. In this regard, receiving the device related information of a component of the system for automated material delivery 704 may include receiving the device related information 560 of a component of the system for automated material delivery 100 as described herein.

Further, the process of implementing the system for automated material delivery and/or the data collection system 700 may include transmitting the device related information to the data collection system 706. In this regard, transmitting the device related information to the data collection system 706 may include transmitting the device related information 560 to the data collection system 590 as described herein.

Additionally, the process of implementing the system for automated material delivery and/or the data collection system 700 may include analyzing the device related information by the data collection system 708. In this regard, analyzing the device related information by the data collection system 708 may include analyzing the device related information 560 by the data collection system 590 as described herein.

In aspects, the analyzing the device related information by the data collection system 708 may include analysis, determination, processing, and/or the like for one or more components of the device manufacturing facility 500 including the service element 200, the dispensing machine 300, the material delivery device 400, and/or the like as it relates to automated process control, automated error prediction & recovery, Data Analytics and Traceability, sensor data, alarm states, commanded operations, dispense metrics, production health, automated process control routines, settings to meet performance specifications, classify normal vs abnormal dispensing states, process control algorithms to adjust settings as necessary, recorded sensor data to predict, recognize, and recover from common alarms and error states with minimal operator intervention, control of the various machines of the system for automated material delivery 100, and/or the like as described herein.

Accordingly, the disclosure set forth a device, system, and method for automated material delivery to a dispensing machine that will reduce contamination of the clean room and limit impact on the quality of the resulting electronic devices. Moreover, the disclosure set forth a device, system, and method for automated material delivery to a dispensing machine that provides data, information, and/or the like for operation, analysis, and/or the like of the various systems associated with the dispensing machine.

The following are a number of nonlimiting EXAMPLES of aspects of the disclosure.

One EXAMPLE includes: a material delivery device that includes side walls, a top wall, a floor, an interior space, and a back wall. The material delivery device in addition includes a machine readable code device. The material delivery device moreover includes at least one power connector configured to provide power to components of the material delivery device. The material delivery device also includes at least one sensor configured to sense a physical characteristic associated with the material delivery device and/or the service element to generate, in part, device related information. The material delivery device further includes a transceiver configured to transmit the device related information to a controller. The material delivery device in addition includes a holding mechanism arranged within the interior space and configured to receive and/or securely hold the service element.

The above-noted EXAMPLE may further include any one or a combination of more than one of the following EXAMPLES: The material delivery device of the above-noted EXAMPLE where the at least one sensor may include a temperature sensor. The material delivery device of the above-noted EXAMPLE where the material delivery device may include a configuration of a front opening unified pod (FOUP) that is configured to hold the service element. The material delivery device of the above-noted EXAMPLE may include a connection assembly configured to connect to a component of a transportation system. The material delivery device of the above-noted EXAMPLE where the service element includes a machine-readable code. The material delivery device of the above-noted EXAMPLE where the holding mechanism is configured to engage a surface of the service element. The material delivery device of the above-noted EXAMPLE where the holding mechanism may include as an elastic component, a gripper component, a material component, a friction fit component, and/or a holder component. The material delivery device of the above-noted EXAMPLE where the service element may include at least one of a syringe of material, a dispenser valve, a dispenser cartridge, and/or a dispenser cup. The material delivery device of the above-noted EXAMPLE where the machine may include a dispensing machine. The system of the above-noted EXAMPLE and the system for automated material delivery may include: a machine configured to use a service element; a controller configured to provide operation, control, and/or oversight of the service element, the material delivery device, and/or the machine; and at least one machine code reading device configured to read the machine readable code device of the material delivery device and/or a machine readable code device of the service element. The system of the above-noted EXAMPLE where the controller is configured to provide an error indication and/or stop operation when the controller determines that the material delivery device and/or the service element is incorrect based on the device related information. The system of the above-noted EXAMPLE where the machine may include a conveyance system configured to remove the service element from the material delivery device. The system of the above-noted EXAMPLE where the machine is configured to move the service element onto an operative portion of the machine. The system of the above-noted EXAMPLE where the service element may include at least one of a syringe of material, a dispenser valve, a dispenser cartridge, and/or a dispenser cup. The system of the above-noted EXAMPLE where the service element may include connections configured to connect to an operative portion in order to provide actuation of the dispenser valve. The system of the above-noted EXAMPLE where the machine is configured to dispense a fluid from the syringe of material through the dispenser cartridge by a controlled operation of the dispenser valve. The system of the above-noted EXAMPLE where the service element further may include an attachment plate and portions of the service element are configured to be attached to the attachment plate; and where the attachment plate may include connections configured to connect to corresponding connections of an operative portion of the machine. The system of the above-noted EXAMPLE may include a module device configured as an equipment front end module (EFEM). The system of the above-noted EXAMPLE where the module device may include a refrigerated compartment to hold the material delivery device and/or the service element. The system of the above-noted EXAMPLE where the module device is configured to convey the material delivery device and/or the service element along a transport path to and from the machine. The system of the above-noted EXAMPLE where the module device may include a conveyance system configured to remove the service element from the material delivery device. The system of the above-noted EXAMPLE may include a turret style tool changer configured to be located in the module device and/or the machine. The system of the above-noted EXAMPLE where the turret style tool changer may include a plurality of attachment portions configured to engage and hold one or more components of the service element. The system of the above-noted EXAMPLE may include a transportation system configured to move the material delivery device together with the service element to the machine. The system of the above-noted EXAMPLE where the transportation system is configured to move along a transport path within the device manufacturing facility to the machine. The system of the above-noted EXAMPLE where the transportation system may include an automated material handling-system (AMHS) and/or an automated guided vehicle (AGV). The system of the above-noted EXAMPLE may include: a data collection system configured to receive, analyze, store, and provide the device related information related to the system for automated material delivery, the service element, the machine, the device manufacturing facility, a module device, and/or a transportation system. The system of the above-noted EXAMPLE where the data collection system may include at least one processor, at least one database, at least one network interface, at least one input output device, and at least one memory. The system of the above-noted EXAMPLE where the device related information may include at least one of the following: date and time of particular operations, date and time of dispense, machine serial number, pressures, temperatures, scripted offset data, dispense settings, dispense metrics, valve serial number, cycles, calibration data, encoder traces, cartridge serial number, cycles, consumable life, fluid lot number, pot life, syringe level, and/or wafer serial number. The system of the above-noted EXAMPLE where the data collection system and the machine code reading device are configured to identify a component of the system for automated material delivery. The system of the above-noted EXAMPLE where the data collection system is configured to receive the device related information of a component of the system for automated material delivery. The system of the above-noted EXAMPLE where the data collection system is configured to transmit the device related information. The system of the above-noted EXAMPLE where the data collection system is configured to perform analysis of the device related information by the data collection system. The system of the above-noted EXAMPLE where the analysis of the device related information by the data collection system may include analysis, determination, and/or processing for one or more components of the device manufacturing facility including the service element, the machine, and/or the material delivery device. The system of the above-noted EXAMPLE where the analysis relates to automated process control, automated error prediction & recovery, data analytics and traceability, sensor data, alarm states, commanded operations, dispense metrics, production health, automated process control routines, settings to meet performance specifications, classify normal vs abnormal dispensing states, process control algorithms to adjust settings as necessary, recorded sensor data to predict, recognize, and recover from common alarms and error states with minimal operator intervention, and/or control of various machines of the system for automated material delivery.

One EXAMPLE includes: a material delivery process that includes implementing a material delivery device. The material delivery process in addition includes configuring the material delivery device with side walls, a top wall, a floor, an interior space, and a back wall. The material delivery process moreover includes configuring the material delivery device with a machine readable code device. The material delivery process also includes configuring the material delivery device with at least one power connector configured to provide power to components of the material delivery device. The material delivery process further includes configuring the material delivery device with at least one sensor to sense a physical characteristic associated with the material delivery device and/or the service element to generate, in part, device related information. The material delivery process in addition includes configuring the material delivery device with a transceiver to transmit the device related information to a controller. The material delivery process moreover includes configuring the material delivery device with a holding mechanism arranged within the interior space to receive and/or securely hold the service element.

The above-noted EXAMPLE may further include any one or a combination of more than one of the following EXAMPLES: The material delivery process of the above-noted EXAMPLE where the at least one sensor may include a temperature sensor. The material delivery process of the above-noted EXAMPLE where the material delivery device may include a configuration of a front opening unified pod (FOUP) that is configured to hold the service element. The material delivery process of the above-noted EXAMPLE may include configuring the material delivery device with a connection assembly configured to connect to a component of a transportation system. The material delivery process of the above-noted EXAMPLE where the service element includes a machine-readable code. The material delivery process of the above-noted EXAMPLE where the holding mechanism is configured to engage a surface of the service element. The material delivery process of the above-noted EXAMPLE where the holding mechanism may include as an elastic component, a gripper component, a material component, a friction fit component, and/or a holder component. The material delivery process of the above-noted EXAMPLE where the service element may include at least one of a syringe of material, a dispenser valve, a dispenser cartridge, and/or a dispenser cup. The material delivery process of the above-noted EXAMPLE where the machine may include a dispensing machine. The material delivery process of the above-noted EXAMPLE may include: implementing a machine configured to use a service element; implementing a controller to provide operation, control, and/or oversight of the service element, the material delivery device, and/or the machine; and implementing at least one machine code reading device to read the machine readable code device of the material delivery device and/or a machine readable code device of the service element. The material delivery process of the above-noted EXAMPLE where the controller is configured to provide an error indication and/or stop operation when the controller determines that the material delivery device and/or the service element is incorrect based on the device related information. The material delivery process of the above-noted EXAMPLE where the machine may include a conveyance system configured to remove the service element from the material delivery device. The material delivery process of the above-noted EXAMPLE where the machine is configured to move the service element onto an operative portion of the machine. The material delivery process of the above-noted EXAMPLE where the service element may include at least one of a syringe of material, a dispenser valve, a dispenser cartridge, and/or a dispenser cup. The material delivery process of the above-noted EXAMPLE where the service element may include connections configured to connect to an operative portion in order to provide actuation of the dispenser valve. The material delivery process of the above-noted EXAMPLE where the machine is configured to dispense a fluid from the syringe of material through the dispenser cartridge by a controlled operation of the dispenser valve. The material delivery process of the above-noted EXAMPLE where the service element further may include an attachment plate and portions of the service element are configured to be attached to the attachment plate; and where the attachment plate may include connections configured to connect to corresponding connections of an operative portion of the machine. The material delivery process of the above-noted EXAMPLE may include implementing a module device configured as an equipment front end module (EFEM). The material delivery process of the above-noted EXAMPLE where the module device may include a refrigerated compartment to hold the material delivery device and/or the service element. The material delivery process of the above-noted EXAMPLE where the module device is configured to convey the material delivery device and/or the service element along a transport path to and from the machine. The material delivery process of the above-noted EXAMPLE where the module device may include a conveyance system configured to remove the service element from the material delivery device. The material delivery process of the above-noted EXAMPLE may include implementing a turret style tool changer configured to be located in the module device and/or the machine. The material delivery process of the above-noted EXAMPLE where the turret style tool changer may include a plurality of attachment portions configured to engage and hold one or more components of the service element. The material delivery process of the above-noted EXAMPLE may include implementing a transportation system configured to move the material delivery device together with the service element to the machine. The material delivery process of the above-noted EXAMPLE where the transportation system is configured to move along a transport path within the device manufacturing facility to the machine. The material delivery process of the above-noted EXAMPLE where the transportation system may include an automated material handling-system (AMHS) and/or an automated guided vehicle (AGV). The material delivery process of the above-noted EXAMPLE may include: implementing a data collection system configured to receive, analyze, store, and provide the device related information for the service element, the machine, the device manufacturing facility, a module device, and/or a transportation system. The material delivery process of the above-noted EXAMPLE where the data collection system may include at least one processor, at least one database, at least one network interface, at least one input output device, and at least one memory. The material delivery process of the above-noted EXAMPLE where the device related information may include at least one of the following: date and time of particular operations, date and time of dispense, machine serial number, pressures, temperatures, scripted offset data, dispense settings, dispense metrics, valve serial number, cycles, calibration data, encoder traces, cartridge serial number, cycles, consumable life, fluid lot number, pot life, syringe level, and/or wafer serial number. The material delivery process of the above-noted EXAMPLE may include identifying a component for automated material delivery with the data collection system. The material delivery process of the above-noted EXAMPLE may include receiving device related information of a component with the data collection system. The material delivery process of the above-noted EXAMPLE may include transmitting the device related information with the data collection system. The material delivery process of the above-noted EXAMPLE may include performing analysis of the device related information with the data collection system. The material delivery process of the above-noted EXAMPLE where the analysis of the device related information by the data collection system may include analysis, determination, and/or processing for one or more components of the device manufacturing facility including the service element, the machine, and/or the material delivery device. The material delivery process of the above-noted EXAMPLE where the analysis relates to automated process control, automated error prediction & recovery, data analytics and traceability, sensor data, alarm states, commanded operations, dispense metrics, production health, automated process control routines, settings to meet performance specifications, classify normal vs abnormal dispensing states, process control algorithms to adjust settings as necessary, recorded sensor data to predict, recognize, and recover from common alarms and error states with minimal operator intervention, and/or control of various machines for automated material delivery.

As may be appreciated by those skilled in the art, the illustrated structure is a logical structure and not a physical one. Accordingly, the illustrated modules can be implemented by employing various hardware and software components. In addition, two or more of the logical components can be implemented as a single module that provides functionality for both components. In one aspect, the components are implemented as software program modules.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto another element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over another element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to another element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Aspects of the disclosure may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, Near field communication (NFC), a cellular telephone network, a Personal Communications Service (PCS), using known protocols such as the Global System for Mobile Communications (GSM), CDMA (Code-Division Multiple Access), GSM/EDGE and UMTS/HSPA network technologies, Long Term Evolution (LTE), 5G (5 th generation mobile networks or 5th generation wireless systems), WiMAX, HSPA+, W-CDMA (Wideband Code-Division Multiple Access), CDMA2000 (also known as C2K or IMT Multi-Carrier (IMT-MC)), Wireless Fidelity (Wi-Fi), Bluetooth, and/or the like, and/or a combination of two or more thereof. The NFC standards cover communications protocols and data exchange formats, and are based on existing radio-frequency identification (RFID) standards including ISO/IEC 14443 and FeliCa. The standards include ISO/IEC 18092[3] and those defined by the NFC Forum

The disclosure may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

Further in accordance with various aspects of the disclosure, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the disclosure is considered to include a tangible storage medium or distribution medium, as listed herein and including art-recognized equivalents and successor media, in which the software implementations herein are stored.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

Aspects of the disclosure may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

The artificial intelligence and/or machine learning may utilize any number of approaches including one or more of cybernetics and brain simulation, symbolic, cognitive simulation, logic-based, anti-logic, knowledge-based, sub-symbolic, embodied intelligence, computational intelligence and soft computing, machine learning and statistics, and the like.

Aspects of the disclosure may include a server executing an instance of an application or software configured to accept requests from a client and giving responses accordingly. The server may run on any computer including dedicated computers. The computer may include at least one processing element, typically a central processing unit (CPU), and some form of memory. The processing element may carry out arithmetic and logic operations, and a sequencing and control unit may change the order of operations in response to stored information. The server may include peripheral devices that may allow information to be retrieved from an external source, and the result of operations saved and retrieved. The server may operate within a client-server architecture. The server may perform some tasks on behalf of clients. The clients may connect to the server through the network on a communication channel as defined herein. The server may use memory with error detection and correction, redundant disks, redundant power supplies and so on.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

1. A material delivery device configured to provide delivery of a service element to a machine within a device manufacturing facility, the material delivery device comprising:
side walls, a top wall, a floor, an interior space, and a back wall;
a machine readable code device;
at least one power connector configured to provide power to components of the material delivery device;
at least one sensor configured to sense a physical characteristic associated with the material delivery device and/or the service element to generate, in part, device related information;
a transceiver configured to transmit the device related information to a controller; and
a holding mechanism arranged within the interior space and configured to receive and/or securely hold the service element.

2. The material delivery device according to claim 1 wherein the at least one sensor comprises a temperature sensor.

3. The material delivery device according to claim 1 wherein the material delivery device comprises a configuration of a front opening unified pod (FOUP) that is configured to hold the service element.

4. The material delivery device according to claim 1 further comprising a connection assembly configured to connect to a component of a transportation system.

5. The material delivery device according to claim 1 wherein the service element includes a machine-readable code.

6. The material delivery device according to claim 1 wherein the holding mechanism is configured to engage a surface of the service element.

7. The material delivery device according to claim 1 wherein the holding mechanism comprises as an elastic component, a gripper component, a material component, a friction fit component, and/or a holder component.

8. The material delivery device according to claim 1 wherein the service element comprises at least one of a syringe of material, a dispenser valve, a dispenser cartridge, a cleaning strip, a fiducial tile, a purge cup, a scale cup, a cleaning strip, and/or a dispenser cup.

9. The material delivery device according to claim 1 wherein the machine comprises a dispensing machine.

10. A system for automated material delivery configured to provide delivery of a service element to a machine, the system for automated material delivery comprising the material delivery device according to claim 1 and the system for automated material delivery further comprising:
a machine configured to use a service element;
a controller configured to provide operation, control, and/or oversight of the service element, the material delivery device, and/or the machine; and
at least one machine code reading device configured to read the machine readable code device of the material delivery device and/or a machine readable code device of the service element.

11. The system for automated material delivery according to claim 10 wherein the controller is configured to provide an error indication and/or stop operation when the controller determines that the material delivery device and/or the service element is incorrect based on the device related information.

12. The system for automated material delivery according to claim 10 wherein the machine comprises a conveyance system configured to remove the service element from the material delivery device.

13. The system for automated material delivery according to claim 10 wherein the machine is configured to move the service element onto an operative portion of the machine.

14. The system for automated material delivery according to claim 10 wherein the machine comprises a conveyance system configured to insert the service element into the material delivery device.

15.-19. (canceled)

20. The system for automated material delivery according to claim 10 further comprising a module device configured as an equipment front end module (EFEM).

21. The system for automated material delivery according to claim 20 wherein the module device comprises a refrigerated compartment to hold the material delivery device and/or the service element.

22. The system for automated material delivery according to claim 20 wherein the module device is configured to convey the material delivery device and/or the service element along a transport path to and from the machine.

23.-38. (canceled)

39. A material delivery process to provide delivery of a service element to a machine within a device manufacturing facility, the material delivery process comprising:
implementing a material delivery device;
configuring the material delivery device with side walls, a top wall, a floor, an interior space, and a back wall;
configuring the material delivery device with a machine readable code device;
configuring the material delivery device with at least one power connector configured to provide power to components of the material delivery device;
configuring the material delivery device with at least one sensor to sense a physical characteristic associated with the material delivery device and/or the service element to generate, in part, device related information;
configuring the material delivery device with a transceiver to transmit the device related information to a controller; and
configuring the material delivery device with a holding mechanism arranged within the interior space to receive and/or securely hold the service element.

40. The material delivery process according to claim 39 wherein the at least one sensor comprises a temperature sensor.

41. The material delivery process according to claim 39 wherein the material delivery device comprises a configuration of a front opening unified pod (FOUP) that is configured to hold the service element.

42.-108. (canceled)
